(19) United States
(12) Patent Application Publication
(10) Pub. No.: US 2026/0069382 A1
(43) Pub. Date: Mar. 12, 2026

(54) METHODS AND SYSTEMS FOR DESIGNING DENTAL APPLIANCES WITH ENHANCED RETENTION ON TEETH

(71) Applicant: Align Technology, Inc., San Jose, CA (US)

(72) Inventors: Iman Shojaei, San Jose, CA (US); Danial Kia, San Jose, CA (US); Eric Yau, Santa Clara, CA (US); Jun Sato, San Jose, CA (US); John Y. Morton, San Jose, CA (US)

(21) Appl. No.: 19/320,633

(22) Filed: Sep. 5, 2025

Related U.S. Application Data
(60) Provisional application No. 63/691,803, filed on Sep. 6, 2024.

(51) Int. Cl. A61C 7/00; A61C 7/08; G06F 30/27

(52) U.S. Cl. CPC A61C 7/002; A61C 7/08; G06F 30/27

(57) ABSTRACT

Methods and systems for designing dental appliances with enhanced retention on teeth are provided. In some embodiments, a method includes receiving a digital representation of a tooth arrangement for a patient's teeth. The method can also include generating a plurality of candidate dental appliances for the tooth arrangement. The method can further include determining a retention parameter for each candidate dental appliance of the plurality of candidate dental appliances, where the retention parameter is indicative of how well the candidate dental appliance is retained on the patient's teeth. The method can further include selecting at least one candidate dental appliance based on the retention parameters for the plurality of candidate dental appliances. The method can further include generating instructions for fabricating the at least one candidate dental appliance.

### CROSS-REFERENCE TO RELATED APPLICATION(S)

The present application claims the benefit of priority to U.S. Provisional Application No. 63/691,803, filed Sep. 6, 2024, the disclosure of which is incorporated by reference herein in its entirety.

### TECHNICAL FIELD

The present technology generally relates to dental and orthodontic treatment, and in particular, to methods and systems for designing dental appliances with enhanced retention on teeth.

### BACKGROUND

Dental appliances are used to treat various dental conditions such as dental malocclusions, jaw dysfunction/misalignment, functional and/or aesthetic conditions, endodontic conditions, and others. Dental appliances have conventionally been rigidly attached (e.g., semi-permanently bonded) to the teeth of a patient. For instance, braces are secured to the patient's teeth via brackets affixed on teeth surfaces. Such dental appliances have limited flexibility, force distribution profiles, comfort, and aesthetics. Removable dental appliances can provide improvements over some of these limitations, such as providing the flexibility to selectively wear and remove the dental appliances from the patient's teeth. However, these removable dental appliances may suffer from suboptimal retention on the patient's teeth. For instance, a removable dental appliance may be too loose, which can result in accidental release of the dental appliance from the patient's teeth and/or reduced treatment efficacy, or may be too rigid, which can make the dental appliance difficult to remove and/or cause unintended force transmission. Accordingly, there is a need for improved retention of dental appliances.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIGS. 1A and 1B illustrate dental appliances with different amounts of interproximal penetration, in accordance with embodiments of the present technology.

FIGS. 2A and 2B illustrate dental appliances with different amounts of gingival trim, in accordance with embodiments of the present technology.

FIGS. 2C and 2D illustrate contact regions for enhancing dental appliance retention, in accordance with embodiments of the present technology.

FIG. 3 is a block diagram providing a general overview of a workflow for predicting dental appliance retention on a patient's teeth, in accordance with embodiments of the present technology.

FIG. 4 is a block diagram illustrating a representative example of a workflow for predicting dental appliance retention on a patient's teeth using a machine learning model, in accordance with embodiments of the present technology.

FIG. 5 is a schematic illustration of a workflow for generating image slices from a 3D model, in accordance with embodiments of the present technology.

FIG. 6 is a schematic diagram illustrating a machine learning architecture for predicting dental appliance retention on a tooth arrangement, in accordance with embodiments of the present technology.

FIG. 7 is a schematic diagram illustrating a machine learning architecture for predicting dental appliance retention on a tooth arrangement, in accordance with embodiments of the present technology.

FIG. 8 is a flow diagram illustrating a method for training a retention prediction machine learning model, in accordance with embodiments of the present technology.

FIG. 9 is a flow diagram illustrating a method for designing and/or manufacturing a dental appliance with improved retention, in accordance with embodiments of the present technology.

FIG. 10 is a flow diagram illustrating a method for designing and/or manufacturing a dental appliance with improved retention, in accordance with embodiments of the present technology.

FIG. 11 is a schematic illustration of a workflow for designing and/or manufacturing a dental appliance with improved retention, in accordance with embodiments of the present technology.

FIG. 12A illustrates a representative example of a tooth repositioning appliance configured in accordance with embodiments of the present technology.

FIG. 12B illustrates a tooth repositioning system including a plurality of appliances, in accordance with embodiments of the present technology.

FIG. 12C illustrates a method of orthodontic treatment using a plurality of appliances, in accordance with embodiments of the present technology.

FIG. 13 illustrates a method for designing an orthodontic appliance, in accordance with embodiments of the present technology.

FIG. 14 illustrates a method for digitally planning an orthodontic treatment and/or design or fabrication of an appliance, in accordance with embodiments of the present technology.

### DETAILED DESCRIPTION

The present technology relates to systems and methods for predicting and/or improving the retention of dental appliances on a patient's teeth. In some embodiments, for example, the present technology provides a method including receiving a digital representation (e.g., a 3D model) of a tooth arrangement for a patient's teeth. The method can further include generating a plurality of candidate dental appliances (e.g., aligners, retainers, palatal expanders) for the tooth arrangement. The method can also include determining a retention parameter (e.g., a quantitative value, a qualitative assessment, or a combination thereof) for each candidate dental appliance of the plurality of candidate dental appliances, where the retention parameter is indicative of how well the candidate dental appliance is retained on the patient's teeth. The method can further include selecting at least one candidate dental appliance based on the retention parameters for the plurality of candidate dental appliances. For example, the selected dental appliance(s) can exhibit good retention on the patient's teeth while also meeting other design criteria, such as maintaining the correct force application, having a satisfactory aesthetic appearance, etc. The method can also include generating instructions for fabricating (e.g., via additive manufacturing) the at least one candidate dental appliance.

The present technology can provide many advantages compared to conventional methods and systems for dental appliance design and retention. For instance, non-removable dental appliances such as braces can be obtrusive, uncomfortable, and/or inflexible, while poorly fitting removable dental appliances may be prone to accidental release and/or misalignment, and/or cause further malocclusion via unintentional force delivery. Additionally, it can be challenging and time-consuming to determine how to optimize various appliance parameters to achieve good retention while also fulfilling other design criteria (e.g., correct force application, aesthetics). The methods and systems provided herein can rapidly and accurately predict whether a dental appliance will exhibit satisfactory retention prior to its manufacture, thus saving time, money, and resources that would otherwise be wasted in designing and fabricating dental appliances that are not suitable for patient use. Further, the opportunity to optimize and/or select candidate dental appliances based on their predicted retention can ensure proper, patient-customized treatment and improve treatment outcomes. For instance, a retention prediction model can be used to identify a dental appliance having an improved retention over other candidate dental appliances. Moreover, the methods and systems provided herein provide the ability to screen large numbers of candidate dental appliances to identify a dental appliance that has satisfactory retention while also meeting other appliance design criteria. Additionally, candidate dental appliances can be iteratively modified until an optimal design based on retention is found, without having to physically produce and/or test the candidate dental appliances.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Dental Appliance Retention

Removable dental appliances can be used to treat various dental conditions while also allowing the patient to temporarily take off the dental appliance when desired (e.g., when eating or drinking) and/or allowing different appliances to be worn on the teeth to apply different forces as treatment progresses. Examples of removable dental appliances include, for example, aligners, retainers, palatal expanders, mouth guards, and oral sleep devices, and are discussed in greater detail in Section II below. The retention of a removable dental appliance on a patient's teeth may be complicated by the relatively smooth and/or uniform tooth surface topography, which may reduce the engagement between the dental appliance and the teeth. Without the use of adhesives, attachments, and/or other coupling elements to enhance engagement, it can be difficult to ensure that the dental appliance is properly retained on the teeth surfaces. For instance, a dental appliance may rely primarily or solely on in-plane, out-of-plane, shear, normal, contact, and/or frictional forces between the dental appliance and the patient's teeth to retain the dental appliance on the patient's teeth. If these forces insufficiently retain the dental appliance on the patient's teeth, then the dental appliance may slip off the teeth or may not seat properly on the teeth, which may result in poor and/or improper force transmission to the teeth. On the other hand, if these forces are excessively high, then the dental appliance may be difficult to place on or remove from the teeth and/or may apply unintended forces to the patient's teeth. The retention of a dental appliance on a patient's teeth may be an issue both during an active treatment, such as with the use of aligners or palatal expanders to reposition a patient's teeth from a first tooth arrangement to a second tooth arrangement, as well as during post-treatment, such as with the use of retainers to maintain the teeth in a desired tooth arrangement. Since dental appliances come in a myriad of geometries and may be customized to a patient's needs, the retention of dental appliances may benefit from patient-by-patient consideration.

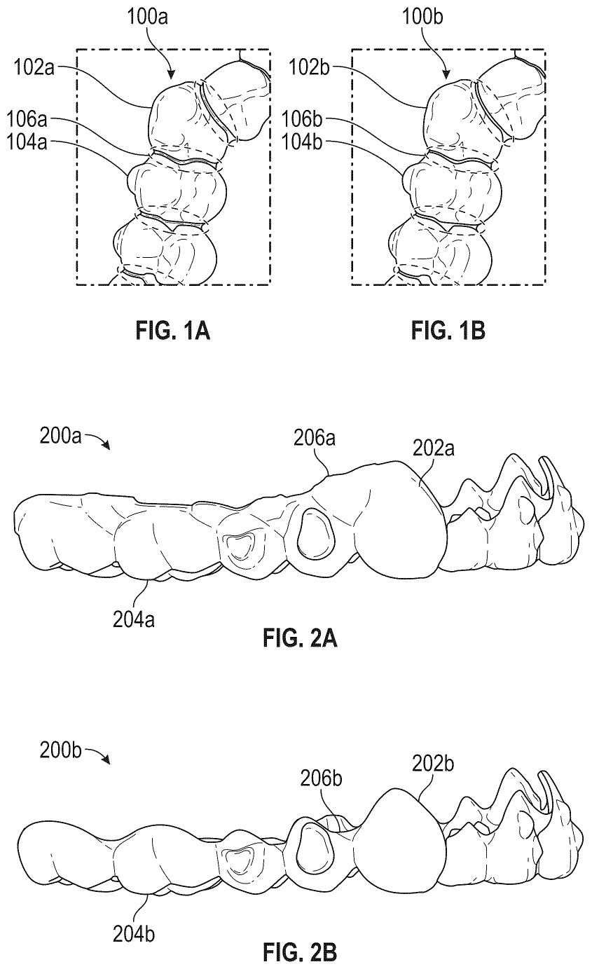

Retention of a dental appliance may be improved by adjusting the appliance geometry. For example, FIGS. 1A and 1B illustrate dental appliances with different amounts of interproximal penetration, in accordance with embodiments of the present technology. Specifically, FIG. 1A is a top view of a first dental appliance 100a with greater interproximal penetration and FIG. 1B is a top view of a second dental appliance 100b with reduced interproximal penetration.

Referring first to FIG. 1A, the first dental appliance 100a can include a shell 102a having a plurality of cavities 104a configured to receive a patient's teeth. The shell 102a can include interproximal regions 106a (encircled) between the cavities 104a corresponding to the interproximal areas of the received teeth. The interproximal regions 106a of the shell 102a can extend inwardly toward the spaces between the teeth, e.g., by a first interproximal penetration depth relative to the surrounding surfaces of the shell 102a (e.g., the occlusal, buccal, and/or lingual surfaces). FIG. 1B depicts a second dental appliance 100b including a shell 102b having a plurality of cavities 104b configured to receive a patient's teeth. The overall geometry of the second dental appliance 100b can be similar to the geometry of the first dental appliance 100a except that the second dental appliance 100b includes shallower interproximal regions 106b (encircled) of the shell 102b. For instance, the interproximal regions 106b can extend inwardly toward the spaces between the teeth at a second interproximal penetration depth less than the first interproximal penetration depth of the shell 102a.

In some examples, the interproximal penetration depths of dental appliances can affect the retention of the dental appliances on a patient's dentition. For instance, for some patients, a larger interproximal penetration depth (e.g., as shown in FIG. 1A) may provide for improved retention on the patient's teeth. This may be due to an increased surface area of the dental appliance arising from the larger interproximal penetration depth, which produces a greater contact and/or force transmission area between the dental appliance and the patient's teeth. However, an excessively large interproximal penetration depth may result in a dental appliance that is excessively rigid such that the dental appliance is difficult to remove, and/or may be uncomfortable for the patient to wear. Accordingly, the optimal interproximal penetration depth of a dental appliance for retention on a patient's teeth may vary from patient to patient.

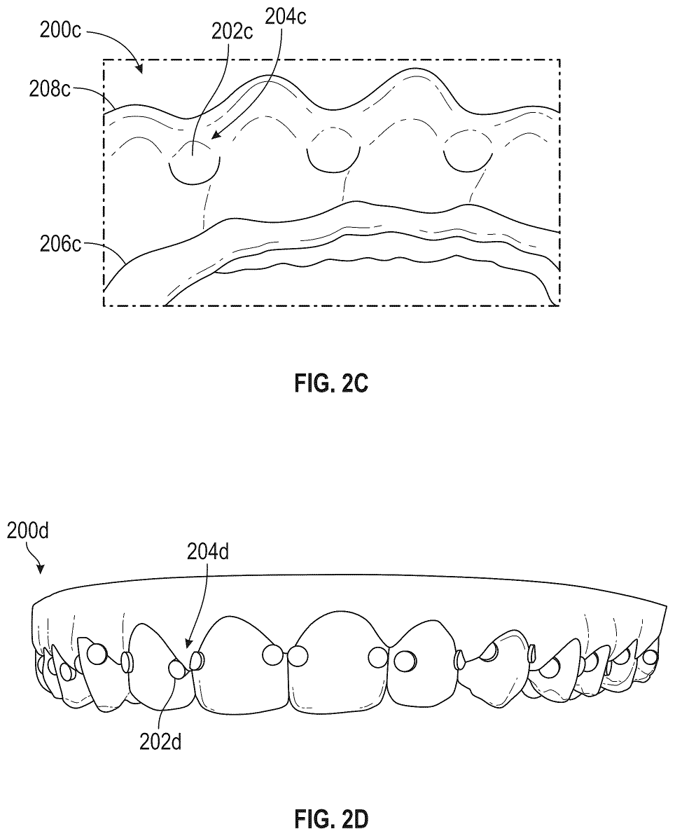

FIGS. 2A and 2B illustrate dental appliances with different amounts of gingival trim, in accordance with embodiments of the present technology. Specifically, FIG. 2A is a side view of a first dental appliance 200a with longer gingival trim and FIG. 2B is a side view of a second dental appliance 200b with shorter gingival trim.

Referring first to FIG. 2A, the first dental appliance 200a can include a shell 202a having a plurality of cavities 204a configured to receive a patient's teeth. The shell 202a can include longer gingival trim regions 206a extending toward and/or over the patient's gingiva. For instance, the shell 202a may extend past the patient's gingival margin such that the shell 202a covers at least a portion of the patient's gingiva. FIG. 2B depicts a second dental appliance 200b including a shell 202b having a plurality of cavities 204b configured to receive a patient's teeth. The overall geometry of the second dental appliance 200b may be similar to the geometry of the first dental appliance 200a except that the second dental appliance 200b includes shorter gingival trim regions 206b of the shell 202b. For instance, the gingival trim regions 206b may not extend past the patient's gingival margin and over the patient's gingiva.

In some examples, the gingival trims of dental appliances can affect the retention of the dental appliances on a patient's dentition. For instance, for some patients, a longer gingival trim (e.g., as depicted in FIG. 2A) may provide for improved retention on the patient's teeth. This may be due to an increased surface area of the dental appliance arising from the longer gingival trim, which produces a greater contact and/or force transmission area between the dental appliance and the patient's intraoral anatomy. However, excessively long gingival trim may be obtrusive and/or uncomfortable. Further, excessively long gingival trim may result in a dental appliance that is excessively rigid and/or difficult to remove. Accordingly, the optimal gingival trim of a dental appliance for retention on a patient's teeth may also vary from patient to patient.

FIGS. 2C and 2D illustrate contact regions for enhancing dental appliance retention, in accordance with embodiments of the present technology. Specifically, FIG. 2C is a rear view of an interior of a third dental appliance 200c with contact regions 202c located proximate to interproximal regions 204c of the third dental appliance 200c, and FIG. 2D is a front view of a dental arch 200d showing locations 202d for contact regions for a dental appliance (not shown) proximate to interproximal regions 204d of the dental arch 200d. Contact regions as described herein may refer to indentations, recesses, grooves, depressions, dimples, areas, etc., in a dental appliance that are offset inward relative to surrounding portions of the dental appliance and extend toward the patient's teeth when the dental appliance is worn by the patient. Contact regions may enhance retention of the appliance on the patient's teeth by creating increased interference (e.g., increased pressure and/or contact) between the appliance and selected regions of the teeth (e.g., interproximal regions, gingival regions).

Referring first to FIG. 2C, the third dental appliance 200c can include a shell 206c having a plurality of cavities 208c configured to receive a patient's teeth. The shell 206c can include a plurality of contact regions 202c located proximate to one or more interproximal regions 204c of the third dental appliance 200c. For instance, a single contact region 202c can be located within each interproximal region 204c between neighboring cavities 208c. Each contact region 202c can be an indentation in the shell 206c that extends inward toward the received teeth to enhance contact with the interproximal regions of the teeth, thereby creating interference that enhances retention of the dental appliance 200c on the teeth.

Referring next to FIG. 2D, a dental appliance (not shown) can be designed with contact regions that contact a dental arch 200d at a plurality of locations 202d proximate to the interproximal regions of the dental arch 200d. As shown in FIG. 2D, there can be a pair of locations 202d proximate to each interproximal region, with one location 202d of the pair being mesial to the interproximal region and the other location 202d of the pair being distal to the interproximal region. Similar to the contact regions 202c of FIG. 2C, the contact region for each location 202d can be an indentation in a shell of the dental appliance that extends inward toward the location 202d to enhance contact with the interproximal regions of the teeth, thereby creating interference that enhances retention of the dental appliance on the dental arch 200d.

In some embodiments, the contact regions of dental appliances can affect the retention of the dental appliances on a patient's dentition. For instance, for some patients, a greater number and/or a larger size of contact regions may provide for improved retention on the patient's teeth. This may be due to an increased amount of interference between the dental appliance and the patient's teeth, which may produce a greater contact between the dental appliance and the patient's intraoral anatomy and/or may produce increased local forces to hold the dental appliance against the teeth. However, too many contact regions and/or contact regions that are too large may be uncomfortable, unsightly, and/or result in a dental appliance that is excessively difficult to place on and remove from the teeth. Accordingly, the optimal amount and size of contact regions of a dental appliance for retention on a patient's teeth may also vary from patient to patient.

While FIGS. 1A-2D illustrate dental appliances varying in interproximal penetration depth, gingival trim, and contact regions, dental appliance retention may alternatively or additionally be adjusted based on other geometric features that can be created using 3D printing and/or thermoforming processes. For instance, dental appliances may vary in shape parameters such as appliance-tooth offset, which can correlate to the separation distance between the dental appliance and the patient's teeth. In some examples, a larger appliance-tooth offset can result in a looser-fitting appliance that may not be sufficiently retained. On the other hand, a smaller appliance-tooth offset may be too form-fitting, such that the appliance is difficult to remove. Dental appliances may also vary in appliance thickness, such as at the buccal, lingual, and/or occlusal walls of the appliance. A thicker appliance may provide for greater retention due to inertial forces and/or contact points, whereas a thinner appliance may be easier to remove and/or break. Dental appliances can also vary in extent of coverage. For instance, dental appliances can cover varying amounts of teeth and/or palatal structures. A dental appliance that covers a smaller number of teeth may have a lower retention than a dental appliance that covers a larger number of teeth (e.g., due to reduced contact area). Other suitable shape parameters that may vary from one dental appliance to another include friction features (e.g., appliance features that increase the amount of friction between the appliance and the teeth such as surface roughness), anchor elements (e.g., appliance features configured to mount one or more attachments), staging (e.g., of a treatment plan), overall shape (e.g., goodness-of-fit), etc.

Given the large number of possible dental appliance geometries for a given treatment type, treatment stage, and patient anatomy, it may be challenging to determine what combination of geometric features (e.g., shape parameters) achieves satisfactory and/or optimal retention on a patient's teeth while also fulfilling the other functions of the dental appliance (e.g., applying the correct forces for the particular treatment stage, maintaining a desired aesthetic appearance). To address this issue and more, the present technology provides methods (e.g., computer-implemented methods) and systems for predicting dental appliance retention. The predicted dental appliance retention can be used in appliance design processes to select and/or optimize dental appliances based on retention.

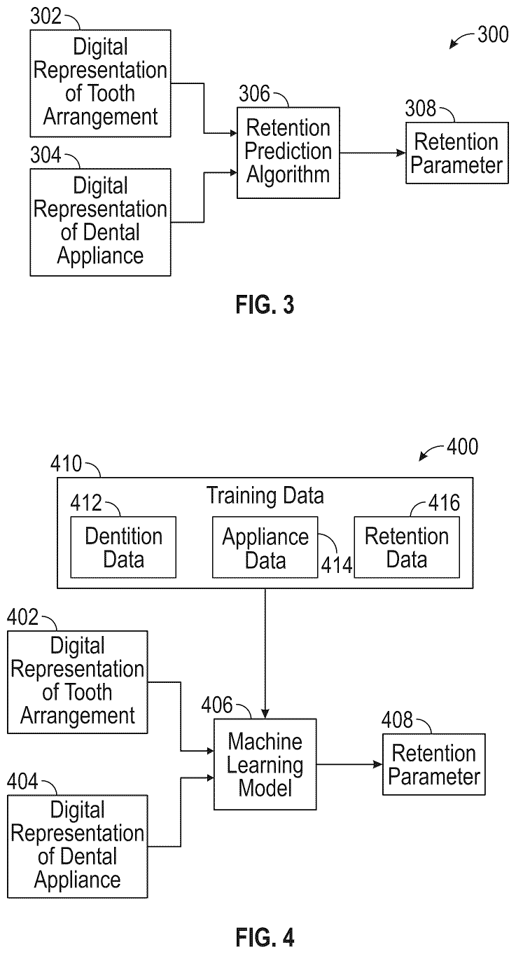

FIG. 3 is a block diagram providing a general overview of a workflow 300 for predicting appliance retention, in accordance with embodiments of the present technology. The workflow 300 can be used to predict how well a particular dental appliance will be retained on a particular arrangement of a patient's teeth. In some embodiments, some or all of the processes described with respect to the workflow 300 are implemented as computer-readable instructions (e.g., program code) that are configured to be executed by one or more processors of a computing device (e.g., a dental appliance design system). The workflow 300 can be utilized and/or combined with any of the methods described herein.

The workflow 300 can include receiving a digital representation of a tooth arrangement 302. The digital representation of the tooth arrangement 302 can depict the 3D geometry and positions of some or all of the patient's teeth and, optionally, of other intraoral structures proximate to the teeth (e.g., gingiva, palate). The digital representation of the tooth arrangement 302 can include or be based on photographs and/or videos (as captured on, e.g., a mobile computing device such as a smartphone, or another suitable device with a camera), scan data (e.g., intraoral and/or extraoral scans), magnetic resonance imaging (MRI) data, and/or radiographic data (e.g., standard x-ray data such as bitewing x-ray data, panoramic x-ray data, cephalometric x-ray data, computed tomography (CT) data, cone-beam computed tomography (CBCT) data, fluoroscopy data). In some embodiments, for example, the digital representation of the tooth arrangement 302 is based on scan data obtained using an intraoral scanner. The scanner can include a probe (e.g., a handheld probe) for optically capturing 3D structures (e.g., by confocal focusing of an array of light beams). Examples of scanners include, but are not limited to, the iTero® intraoral digital scanner manufactured by Align Technology, Inc.

The digital representation of the tooth arrangement 302 can be provided in any suitable file format (e.g., BMP files, PNG files, STL files, STP files). The digital representation of the tooth arrangement 302 can include image-based data, such as one or more 3D digital models (e.g., surface or mesh models, point clouds), 2D images, other digital data generated from the 3D digital models and/or 2D images (e.g., tensors), etc. Alternatively or in combination, the digital representation of the tooth arrangement 302 may include structured data (e.g., data presented in tables, arrays, lists, or other structured formats) that characterizes relevant features of the tooth arrangement. The structured data may include information about one or more teeth (e.g., geometry information such as crown height, crown width, degree of tilt), information about interproximal areas (e.g., interproximal spacing), and/or other anatomical data.

The digital representation of the tooth arrangement 302 can be obtained at any suitable point in time. In some embodiments, the digital representation is of a tooth arrangement of the patient's teeth prior to a dental treatment, such as an initial tooth arrangement before any dental appliances have been worn on the teeth. Alternatively, the digital representation can be of a tooth arrangement of the patient's teeth during a dental treatment, such as an intermediate tooth arrangement corresponding to an intermediate treatment stage of a treatment plan in which one or more dental appliances (e.g., aligners, palatal expanders) have been worn on the teeth. The digital representation can be of a tooth arrangement of the patient's teeth after a dental treatment, such as a final or post-treatment tooth arrangement to be maintained by a retainer.

The workflow 300 can also include receiving a digital representation of a dental appliance 304. The dental appliance 304 can be designed to be worn on the patient's teeth to move the teeth toward the tooth arrangement 302 or to maintain the teeth in the tooth arrangement 302. The digital representation of the dental appliance 304 can depict the 3D geometry of the dental appliance 304 (e.g., the shape and size of the appliance shell, tooth-receiving cavities, etc.). The dental appliance 304 may be a candidate dental appliance for use in a treatment plan for the patient, as will be discussed later herein. For instance, the dental appliance 304 may be an aligner shaped to reposition the patient's teeth from a first tooth arrangement to a second tooth arrangement. As another example, the dental appliance may be a retainer for retaining the patient's teeth in a desired tooth arrangement. In a further example, the dental appliance may be a palatal expander for expanding the patients' dental arch from a first width to a second width. Other examples and details of dental appliances that are applicable to the present technology are provided in Section II below.

The digital representation of the dental appliance 304 can be provided in any suitable file format (e.g., BMP files, PNG files, STL files, STP files). The digital representation of the dental appliance 304 can include image-base data, such as one or more 3D digital models (e.g., surface or mesh models, point clouds), 2D images, other digital data generated from the 3D digital models and/or 2D images (e.g., tensors), etc. Alternatively or in combination, the digital representation of the dental appliance 304 may include structured data (e.g., data presented in tables, arrays, lists, or other structured formats) that characterizes relevant features of the dental appliance. The structured data may include information such as appliance thickness, appliance material, contact region information (e.g., global or local offset), interproximal penetration, etc. Optionally, the structured data of the digital representation of the dental appliance 304 may be associated with structured data of the digital representation of the tooth arrangement 302. For instance, structured data for each tooth may be associated with structured data for the corresponding region of the dental appliance (e.g., the portion of the dental appliance that receives and/or is proximate to the tooth).

In some embodiments, the digital representation of the dental appliance 304 is separate from the digital representation of the tooth arrangement 302 (e.g., the digital representations are two separate digital data files). Alternatively, the digital representation of the dental appliance 304 can be part of the digital representation of the tooth arrangement 302, or vice versa (e.g., the digital representations are part of a single digital data file showing the dental appliance on the tooth arrangement 302).

The workflow 300 can also include inputting the digital representation of the tooth arrangement 302 and the digital representation of the dental appliance 304 into a retention prediction algorithm 306. In some embodiments, the entirety of the digital representation of the tooth arrangement 302 and the digital representation of the dental appliance 304 are input into the retention prediction algorithm 306. However, in other embodiments, only a portion of the digital representation of the tooth arrangement 302 and/or the digital representation of the dental appliance 304 are input into the retention prediction algorithm 306. For instance, the digital representations can be segmented into smaller portions, and only certain segmented portion(s) may be input into the retention prediction algorithm 306. Examples of segmented portions include, but are not limited to, buccal surfaces, lingual surfaces, occlusal surfaces, anterior portions, posterior portions, gingival portions, lower dental arch, upper dental arch, etc. This approach may be advantageous, for example, if retention is to be enhanced only at certain portions of the dental appliance, rather than for the entire dental appliance.

The retention prediction algorithm 306 can be any suitable software algorithm that is configured to predict the retention of the dental appliance on the patient's teeth when the teeth are in the tooth arrangement 302. For instance, the retention prediction algorithm 306 can determine how well the dental appliance would be retained on the patient's teeth if the dental appliance 304 were to be worn by the patient. In some embodiments, the retention prediction algorithm 306 includes comparing a geometry of the tooth arrangement 302 with a geometry of the dental appliance 304. The retention prediction algorithm may also consider force profiles exerted by the dental appliance 304 on the tooth arrangement 302, or vice versa. Further, the retention prediction algorithm 306 may include an evaluation of the material properties of the dental appliance 304 and/or the tooth arrangement 302. Optionally, the retention prediction algorithm 306 may consider the use of attachments and/or other coupling elements positioned on the patient's teeth, if present.

In some embodiments, the retention prediction algorithm 306 includes one or more statistical models. For example, the retention prediction algorithm 306 may statistically assess and/or compare geometric features (e.g., lengths, widths, heights, curvatures, symmetry) of the dental appliance 304 with the tooth arrangement 302, e.g., to predict the amounts and/or locations of engagement between the dental appliance 304 and the tooth arrangement 302. In some embodiments, for instance, the retention prediction algorithm 306 compares the curvature of an inner surface of the dental appliance 304 with the curvature of an outer surface of the tooth arrangement 302. As another example, the retention prediction algorithm 306 may identify and/or evaluate the surface area(s) of the dental appliance 304 that contacts the tooth arrangement 302. Alternatively or in combination, the retention prediction algorithm 306 can utilize a mechanical and/or physics-based model, e.g., to simulate the retention of the dental appliance on the tooth arrangement. For instance, the retention prediction algorithm 306 may employ a finite element method (FEM) model (e.g., a FEM model of the dental appliance and/or tooth arrangement) to determine potential force profiles (e.g., deformation, load-bearing capacity, etc.) and/or expected interactions between the dental appliance 304 and the tooth arrangement 302.

In some embodiments, the retention prediction algorithm 306 is or includes a machine learning model that is trained to predict dental appliance retention on a patient's teeth. The machine learning model can utilize at least one machine learning algorithm, such as any of the following: a regression algorithm (e.g., ordinary least squares regression, linear regression, logistic regression, stepwise regression, multivariate adaptive regression splines, locally estimated scatterplot smoothing), an instance-based algorithm (e.g., k-nearest neighbor, learning vector quantization, self-organizing map, locally weighted learning), regularization algorithms (e.g., ridge regression, least absolute shrinkage and selection operator, clastic net, least-angle regression), a decision tree algorithm (e.g., Iterative Dichotomiser 3 (ID3), C4.5, C5.0, classification and regression trees, chi-squared automatic interaction detection, decision stump, M5), a Bayesian algorithm (e.g., naïve Bayes, Gaussian naïve Bayes, multinomial naïve Bayes, averaged one-dependence estimators, Bayesian belief networks, Bayesian networks, hidden Markov models, conditional random fields), a clustering algorithm (e.g., k-means, single-linkage clustering, k-medians, expectation maximization, hierarchical clustering, fuzzy clustering, density-based spatial clustering of applications with noise (DBSCAN), ordering points to identify cluster structure (OPTICS), non-negative matrix factorization (NMF), latent Dirichlet allocation (LDA), Gaussian mixture model (GMM)), an association rule learning algorithm (e.g., apriori algorithm, equivalent class transformation (Eclat) algorithm, frequent pattern (FP) growth), an artificial neural network algorithm (e.g., perceptrons, neural networks, back-propagation, Hopfield networks, autoencoders, Boltzmann machines, restricted Boltzmann machines, spiking neural nets, radial basis function networks), a deep learning algorithm (e.g., deep Boltzmann machines, deep belief networks, convolutional neural networks, stacked auto-encoders), a dimensionality reduction algorithm (e.g., PCA, independent component analysis (ICA), principle component regression (PCR), partial least squares regression (PLSR), Sammon mapping, multidimensional scaling, projection pursuit, linear discriminant analysis, mixture discriminant analysis, quadratic discriminant analysis, flexible discriminant analysis), an ensemble algorithm (e.g., boosting, bootstrapped aggregation, AdaBoost, blending, gradient boosting machines, gradient boosted regression trees, random forest), or suitable combinations thereof. Additional details and examples of machine learning models that may be used are described below, e.g., in connection with FIG. 4.

The workflow 300 can also include outputting a retention parameter 308. The retention parameter 308 can be indicative of how well the dental appliance 304 is retained on the patient's teeth. In some embodiments, the retention parameter 308 is a quantitative parameter, such as a retention score. For instance, a predicted well-fitting dental appliance may have a high retention score, whereas a predicted poor-fitting dental appliance may have a low retention score. The retention score may be a numeric value within a range from 0 to 1, where 0 is no retention and 1 is ideal and/or satisfactory retention. Many suitable ranges may be used to capture the variation in predicted retention parameters. For example, the retention parameter 308 may be within a range from 0 to 10, 0 to 20, 0 to 50, 0 to 100, etc. In some embodiments, the retention parameter 308 is a qualitative parameter, such as a rating, categorization, etc. For instance, the retention parameter 308 for the dental appliance 304 can be “bad,” “good,” “great,” “near perfect,” “perfect,” etc.

The retention parameter 308 can be or include a global retention parameter 308 that represents the overall predicted retention of the dental appliance 304 across all of the patient's teeth in the tooth arrangement 302. Alternatively or in combination, the retention parameter 308 can be or include local retention parameters that represent predicted retention for subsets of the patient's teeth, for individual teeth, and/or for specific regions of individual teeth, etc. For example, individual regions of the dental appliance 304 and/or tooth arrangement 302 may be assigned a local retention parameter 308 reflecting the local predicted retention of the dental appliance 304 on that particular region of the tooth arrangement 302.

As will be discussed elsewhere herein, the retention parameter 308 can inform treatment decisions. For instance, the retention parameter 308 can be compared to a target retention parameter (e.g., threshold), and the dental appliance may or may not be selected for the treatment plan based on the comparison. In some embodiments, the target retention parameter can include a minimum threshold for retention, e.g., to prevent accidental release of the dental appliance. The target retention parameter may further include a maximum threshold for retention, e.g., to avoid over-retention, where the dental appliance may be uncomfortable and/or difficult to remove. In some embodiments, an unsatisfactory retention parameter may prompt the retention prediction algorithm 306 to request additional dental appliances for consideration.

FIG. 4 is a block diagram illustrating a representative example of a workflow 400 for predicting dental appliance retention on a patient's teeth, in accordance with embodiments of the present technology. The workflow 400 can be incorporated into or otherwise combined with the workflow 300 of FIG. 3. In some embodiments, some or all of the processes described with respect to the workflow 400 are implemented as computer-readable instructions (e.g., program code) that are configured to be executed by one or more processors of a computing device (e.g., a dental appliance design system). The workflow 400 can be utilized and/or combined with any of the methods described herein.

The workflow 400 can include receiving a digital representation of a tooth arrangement 402 and a digital representation of a dental appliance 404. The digital representation of the tooth arrangement 402 can be identical or generally similar to the digital representation of the tooth arrangement 302 of the workflow 300 of FIG. 3, and the digital representation of the dental appliance 404 can be identical or generally similar to the digital representation of the dental appliance 304 of the workflow 300 of FIG. 3. For instance, the digital representation of the tooth arrangement 402 can include data pertaining to the patient's teeth and/or intraoral anatomy. The data may be based on a tooth arrangement 402 prior to a dental treatment or a tooth arrangement 402 during and/or after a dental treatment. The digital representation of the dental appliance 404 can be of a dental appliance suitable for use in a dental treatment for the patient. For instance, the dental appliance 404 can be an aligner for repositioning the patient's teeth or a retainer for maintaining a patient's current tooth arrangement. The dental appliance 404 can be designed to be worn on the patient's teeth to move the teeth toward the tooth arrangement 402 or to maintain the teeth in the tooth arrangement 402.

The workflow 400 can further include inputting the digital representation of the tooth arrangement 402 and the digital representation of the dental appliance 404 into a machine learning model 406. The machine learning model 406 can be configured to output a retention parameter 408, where the retention parameter 408 is indicative of how well the dental appliance 404 is retained on the tooth arrangement 402. The machine learning model 406 can be trained on training data 410 to predict retention, as discussed further below.

The machine learning model 406 can be any machine learning model configured to receive the digital representation of the tooth arrangement 402 and the digital representation of the dental appliance 404 and predict the retention parameter 408. In some embodiments, the machine learning model 406 is or includes a convolutional neural network (CNN) that is trained to perform the prediction. CNNs are a type of machine learning algorithm that can be used in the processing of images and/or other array-like data structures. A CNN is composed of a plurality of layers, with each layer including one or more neurons to which the operations described herein are applied. The CNN can transform input data (e.g., data received at an input layer) into output data (e.g., data output by an output layer) through a network architecture including a plurality of intermediate layers. In some embodiments, the plurality of intermediate layers include one or more convolutional layers. Each convolutional layer of a CNN can apply at least one filter (also known as a “kernel”) to input data from a preceding layer via a convolutional operation. The parameters of the kernel (e.g., kernel size, weight, biases, parameters of the kernel function(s)) can be learned from training data (e.g., using backpropagation). The CNN can optionally include multiple convolutional layers, with the input data for each convolutional layer including output data from a preceding layer (e.g., another convolutional layer or another type of layer).

In some embodiments, the CNN includes one or more additional layers besides the one or more convolutional layers, such as at least one pooling layer and/or at least one fully connected layer. The at least one pooling layer can apply a spatial reduction operation to a preceding layer. In some embodiments, the at least one pooling layer performs dimensionality reduction. The at least one pooling layer can apply any variety of operations, such as max pooling, min pooling, average pooling, and global pooling. The at least one fully connected layer is connected to all preceding and succeeding layers. The at least one fully connected layer can apply a transformation to a preceding layer. In some embodiments, the at least one fully connected layer includes a linear transformation (e.g., affine functions). In some embodiments, the at least one fully connected layer includes a non-linear transformation (e.g., sigmoid, softmax, tanh, rectified linear unit functions). While the CNN has been discussed with respect to the plurality of layers, it should be understood that any of the layers can include one or more neurons at which operations are applied. Further, the CNN can include any arrangement of layers forming a customized network architecture. The prediction produced by the CNN can include output data determined from a convolutional layer, pooling layer, fully connected layer, or any other layer of the CNN.

In embodiments where the machine learning model 406 is or includes a CNN, the digital representations of the tooth arrangement 402 and/or the dental appliance 404 can include image data (e.g., one or more images in any suitable image format, including but not limited to voxel grids, BMP files, PNG files, etc.). In some embodiments, the digital representations of the tooth arrangement 402 and/or the dental appliance 404 are generated by “slicing” a 3D digital model (e.g., a surface or mesh model, point clouds) into a sequence of 2D images that collectively represent the 3D geometry of the tooth arrangement 402 and/or dental appliance 404, respectively. The individual 2D images may be referred to herein as “image slices,” and the sequence of 2D images may be referred to herein as a “volumetric image.” The resulting image data (e.g., image slices and/or volumetric image) can subsequently be used as input into the machine learning model 406, e.g., directly or after conversion into one or more tensors.

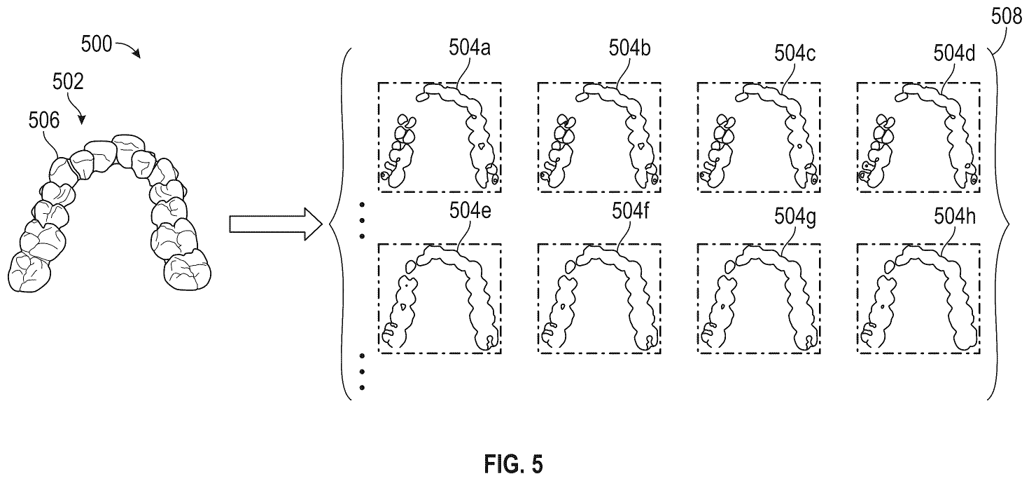

FIG. 5 is a schematic illustration of a workflow 500 for generating image slices from a 3D model, in accordance with embodiments of the present technology. The workflow 500 can be used to produce image data suitable for use with the retention prediction algorithms described herein, such as the machine learning model 406 of FIG. 4. In some embodiments, some or all of the processes described with respect to the workflow 500 are implemented as computer-readable instructions (e.g., program code) that are configured to be executed by one or more processors of a computing device (e.g., a dental appliance design system). The workflow 500 can be utilized and/or combined with any of the methods described herein.

The workflow 500 can include slicing a 3D model 502 of a dental appliance and/or tooth arrangement 506 into a plurality of image slices 504a-504h (collectively, “image slices 504”). In some embodiments, the 3D model 502 is stored as a 3D file format, such as an STL file, STP file, MAX file, FBX file, OBJ file, X3D file, VRML file, 3DS file, 3MF file, DAE file, etc. Slicing the 3D model 502 into the plurality of image slices 504 can include generating a plurality of 2D cross-sections of the 3D model 502 at varying vertical locations (e.g., depths) along the 3D model 502. As depicted, each image slice 504 can be a 2D representation of the cross-sectional geometry of a dental appliance and/or tooth arrangement 506 at a different depth of the dental appliance and/or tooth arrangement 506. For instance, the image slice 504a can correspond to a first depth of the dental appliance and/or tooth arrangement 506, the image slice 504b can correspond to a second depth of the dental appliance and/or tooth arrangement 506, and so on. The image slices 504 can collectively form a volumetric image 508 of the dental appliance and/or tooth arrangement 506.

In some embodiments, the volumetric image 508 is converted into a tensor. The tensor can have dimensions of H by W by D, where H corresponds to the height of the image slices 504 (e.g., in pixels), W corresponds to the width of the image slices 504 (e.g., in pixels), and D corresponds to the number of depths (e.g., channels) at which the image slices 504 were taken. The volumetric image 508 and/or the tensor generated from the volumetric image 508 can be used as input data for a retention prediction algorithm (e.g., the retention prediction algorithm 306 of FIG. 3 and/or the machine learning model 406 of FIG. 4).

In some embodiments, a retention prediction algorithm (e.g., the machine learning model 406 of the workflow 400 of FIG. 4) can include various architectures for predicting retention from input data. In some embodiments, the architectures may vary based on the input data, such as when a digital representation of a tooth arrangement and a digital representation of a dental appliance are inputted into the retention prediction algorithm together or separately. Further, instead of or in addition to image-based data, the retention prediction algorithm may receive structured data, e.g., structured data of one or more of a digital representation of the tooth arrangement or a digital representation of the dental appliance, and the retention prediction algorithm can determine a retention parameter based on the structured data. For instance, the retention prediction algorithm can include a regression machine learning model, such as a feedforward neural network, and the regression machine learning model can be configured to receive and process structured data to generate a prediction of dental appliance retention (e.g., a retention parameter such as a retention score).

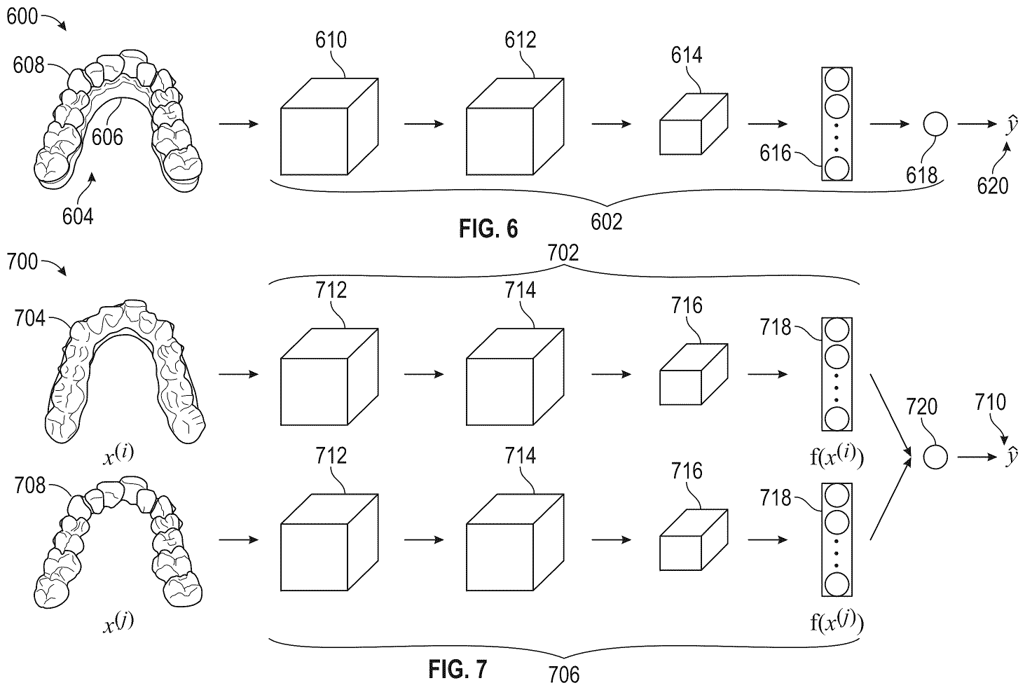

FIG. 6 is a schematic diagram illustrating a machine learning architecture 600 for predicting dental appliance retention on a tooth arrangement, in accordance with embodiments of the present technology. The architecture 600 can be used as part of a machine learning model, such as the machine learning model 406 of the workflow 400 of FIG. 4, to predict how well a dental appliance is retained on a patient's teeth. The architecture 600 can be implemented across any desired software and/or hardware components by any of the systems and devices described herein.

In some embodiments, the architecture 600 includes a neural network 602 configured to receive a single digital representation 604. The digital representation 604 can include both a tooth arrangement 606 and a dental appliance 608. The tooth arrangement 606 can be generally similar to any of the tooth arrangements discussed herein, such as the tooth arrangement 302 of the workflow 300 of FIG. 3. For instance, the tooth arrangement 606 can include data pertaining to the patient's teeth and/or other intraoral anatomy. The tooth arrangement 606 may represent the patient's tooth arrangement before, during, or after a dental treatment. The dental appliance 608 can be generally similar to any of the dental appliances discussed herein, such as the dental appliance 304 of the workflow 300 of FIG. 3. For instance, the dental appliance 608 can be a dental aligner for repositioning the patient's teeth or a retainer for maintaining the patient's current tooth arrangement. The dental appliance 608 can be designed to be worn on the patient's teeth to move the teeth toward the tooth arrangement 606 or to maintain the teeth in the tooth arrangement 606.

In some embodiments, the digital representation 604 may represent the dental appliance 608 positioned on the tooth arrangement 606, similar to how the dental appliance 608 would be worn on a patient's teeth. The digital representation 604 may include markers or other indicators to distinguish the dental appliance 608 from the tooth arrangement 606. For instance, the dental appliance 608 and the tooth arrangement 606 can have different colors, shading, patterns, etc. Optionally, the dental appliance 608 and the tooth arrangement 606 are distinguished by one or more geometric properties such as volume, surface area, thickness, etc. In some embodiments, the digital representation 604 includes labels such as binary labels or description labels (e.g. “tooth,” “appliance”) to distinguish the dental appliance 608 from the tooth arrangement 606. For instance, pixels or voxels belonging to the tooth arrangement 606 can have a first label, and pixels or voxels belonging to the dental appliance 608 have a second, different label.

The digital representation 604 can include image data (e.g., one or more 2D image slices and/or a volumetric image composed of the 2D image slices). The image data can be processed (e.g., converted, manipulated, transformed) into a tensor 610. The tensor 610 can be generally similar to the tensors described with respect to the workflow 500 of FIG. 5. For instance, the tensor 610 can include dimensions of H by W by D, and the tensor 610 may be directly inputted into the neural network 602.

In some embodiments, the neural network 602 is or includes a deep learning neural network that is trained to perform the prediction, such as a CNN. The CNN can be generally similar to the CNN described above with respect to the workflow 400 of FIG. 4. For instance, the CNN can include one or more convolutional layers 612, one or more pooling layers 614, one or more fully connected layers 616, and/or one or more output layers 618. The CNN can be configured to predict a retention parameter 620. For instance, the convolutional layers 612 can apply one or more convolutional operations (e.g., via kernel(s)) to the tensor 610 to extract features from the tensor 610. In some embodiments, the convolutional layers 612 process the entire tensor 610 altogether. Alternatively, the convolutional layers 612 may be applied to separate portions of the tensor 610, e.g., the convolutional layers 612 may independently process each depth of the tensor 610. The pooling layers 614 can be used to reduce the dimensionality of preceding layers, such as to aggregate feature information from the extracted features. The fully connected layers 616 can apply one or more operations to transform the aggregated feature information from preceding layers to an interpretable output layer 618 from which the retention parameter 620 can be indicated. The retention parameter 620 can be generally similar to any of the retention parameters discussed herein, such as the retention parameter 308 of the workflow 300 of FIG. 3. For instance, the retention parameter 620 can be a quantitative score (e.g., using regression), a qualitative score (e.g., using classification), or a combination thereof.

FIG. 7 is a schematic diagram illustrating a machine learning architecture 700 for predicting dental appliance retention on a tooth arrangement, in accordance with embodiments of the present technology. For instance, the architecture 700 can be used as part of a machine learning model, such as the machine learning model 406 of the workflow 400 of FIG. 4. The architecture 700 can be implemented across any desired software and/or hardware components by any of the systems and devices described herein. The architecture 700 can be generally similar to the architecture 600 of FIG. 6, except that the architecture 700 receives two separate digital representations rather than a single digital representation.

In some embodiments, the architecture 700 includes a first neural network 702 configured to receive a digital representation of a tooth arrangement 704 and a second neural network 706 configured to receive a digital representation of a dental appliance 708. In some embodiments, the first neural network 702 and the second neural network 706 can be combined to generate a prediction of a retention parameter 710 indicating how well the dental appliance 708 is retained on the tooth arrangement 704.

The tooth arrangement 704 can be generally similar to any of the tooth arrangements discussed herein, such as the tooth arrangement 302 of the workflow 300 of FIG. 3. For instance, the tooth arrangement 704 can include data pertaining to the patient's teeth and/or other intraoral anatomy. The tooth arrangement 704 may represent the patient's tooth arrangement before, during, or after a dental treatment. The dental appliance 708 can be generally similar to any of the dental appliances discussed herein, such as the dental appliance 304 of the workflow 300 of FIG. 3. For instance, the dental appliance 708 can be a dental aligner for repositioning the patient's teeth or a retainer for maintaining the patient's current tooth arrangement. The dental appliance 708 can be designed to be worn on the patient's teeth to move the teeth toward the tooth arrangement 704 or to maintain the teeth in the tooth arrangement 704.

In the illustrated embodiment, the digital representation of the tooth arrangement 704 is separate from the digital representation of the dental appliance 708. For instance, the digital representation of the tooth arrangement 704 can be in a separate digital file from the digital representation of the dental appliance 708. In some embodiments, while the digital representation of the tooth arrangement 704 and the digital representation of the dental appliance 708 may be separate, they may share a common coordinate axis, reference frame, and/or other spatial mapping. This may be useful, for instance, in determining how the dental appliance 708 is seated on the tooth arrangement 704.

In some embodiments, the digital representation of the tooth arrangement 704 includes first image data of the tooth arrangement 704, and the digital representation of the dental appliance 708 includes second image data of the dental appliance 708. In some embodiments, the first image data can be characterized by x⁽ⁱ⁾, and the second image data can be characterized by x^{(j)}. The image data can include one or more 2D image slices and/or a volumetric image composed of the 2D image slices. The first image data and second image data can be processed (e.g., converted, manipulated, transformed) into respective tensors 712a and 712b. The tensors 712a and 712b can be generally similar to the tensors described elsewhere herein, such as the tensors described with respect to the workflow 500 of FIG. 5.

In some embodiments, the first neural network 702 and the second neural network 706 can each include one or more convolutional layers 714a and 714b, pooling layers 716a and 716b, and/or fully connected layers 718a and 718b for processing data from the tensors 712a and 712b and/or preceding layers, respectively. The convolutional layers 714a and 714b, pooling layers 716a and 716b, and/or fully connected layers 718a and 718b can be generally similar to the convolutional layers discussed elsewhere herein, such as the layers discussed with respect to the workflow 400 of FIG. 4.

As an example, the first neural network 702 can be configured to receive first tensor 712a derived from the digital representation of the tooth arrangement 704. The first neural network 702 may apply one or more convolutional operations to the first tensor 712a via first convolutional layers 714a to extract features from the first tensor 712a. The first neural network 702 may also aggregate feature information from the first convolutional layers 714a using first pooling layers 716a. Similarly, the second neural network 706 can be configured to receive the second tensor 712b derived from the digital representation of the dental appliance 708. The second neural network 706 may apply one or more convolutional operations to the second tensor 712b via second convolutional layers 714b to extract features from the second tensor 712b. The second neural network 706 may aggregate feature information from the second convolutional layers 714b using second pooling layers 716b.

After feature information has been aggregated by the first pooling layer 716a and the second pooling layer 716b, the aggregated information can be received by respective fully connected layers 718a and 718b. The fully connected layers 718a and 718b may be configured to transform the aggregated feature information into a single output layer 720. In some embodiments, the transformation is characterized as functions of x⁽ⁱ⁾ and x^{(j)}, respectively (“f(x⁽ⁱ⁾” and “f(x^{(j)})”). In some embodiments, the respective fully connected layers 718a and 718b converge to output the single output layer 720. The single output layer 720 can then be used to indicate and/or output the retention parameter 710. As discussed elsewhere herein, the retention parameter 710 can include a quantitative score, a qualitative score, or a combination thereof.

Returning to FIG. 4, the machine learning model 406 can be trained using training data 410. In some embodiments, the training data 410 includes dentition data 412, appliance data 414, and retention data 416. The dentition data 412 can include a plurality of digital representations of tooth arrangements similar to those described elsewhere herein. For instance, the dentition data 412 can include 3D models, 2D images generated from the 3D models (e.g., image slices and/or volumetric image composed of image slices), structured data, or a combination thereof. The appliance data 414 can include a plurality of digital representations of dental appliances similar to those described elsewhere herein. For instance, the dental appliances can be dental aligners for repositioning a patient's teeth or retainers for maintaining a patient's current tooth arrangement. The appliance data 414 can include 3D models, 2D images generated from the 3D models (e.g., image slices and/or volumetric image composed of image slices), structured data, or a combination thereof. Each dental appliance in the appliance data 414 can be paired with a corresponding tooth arrangement in the dentition data 412, e.g., the tooth arrangement that the dental appliance is intended to achieve and/or maintain. While the dentition data 412 and appliance data 414 are shown as separate datasets in FIG. 4, in some embodiments, the dentition data 412 and appliance data 414 may be combined into a single dataset in which each dental appliance is combined with a corresponding tooth arrangement, e.g., as depicted in the machine learning architecture 600 of FIG. 6.

The retention data 416 can include a retention parameter corresponding to each dental appliance-tooth arrangement pair, where the retention parameter is indicative of how well the dental appliance is retained on the corresponding tooth arrangement. For example, the retention parameter can be a quantitative or qualitative score, and/or can be indicative of global retention and/or local retention, etc. Together, each tooth arrangement, corresponding dental appliance, and corresponding retention parameter can constitute a training sample of a plurality of training samples, and the machine learning model 406 can be trained using the training samples. For example, each training sample can be represented as (x, y), where x is a volumetric image of a dental appliance on a tooth arrangement, and y is a retention score for the dental appliance on the tooth arrangement. As another example, each training sample can be represented as (x₁, x₂, y), where x₁ is a volumetric image of a tooth arrangement, x₂ is a volumetric image of a dental appliance, and y is a retention score for the dental appliance on the tooth arrangement.

In some embodiments, some or all of the appliance data 414 is generated using an appliance generation algorithm. For instance, the appliance generation algorithm can be configured to automatically generate a plurality of digital representations of dental appliances for one or more tooth arrangements. The dental appliances may vary across one or more shape parameters, such as those discussed above with respect to FIGS. 1A-2B. For instance, the generated dental appliances may be designed to be worn on the same tooth arrangement, but can have varying interproximal penetration, gingival trim, appliance-tooth offset, thickness, extent of coverage, staging, contact regions, friction features, anchor elements, and/or any other geometric features that can be created using 3D printing and/or thermoforming processes. In such embodiments, the retention data 416 for the generated dental appliances can be determined based on experimental data (e.g., actually fabricating the dental appliances and testing their retention) and/or simulation data (e.g., using FEM models and/or other physics-based simulations to predict retention).

Alternatively or in combination, some or all of the appliance data 414 can include digital representations of dental appliances previously worn by a plurality of patients who are undergoing or have undergone dental treatment. For instance, the appliance data 414 can include empirical data from actual dental appliances that have been used in dental treatments. In such embodiments, the retention data 416 for the actual dental appliances can be determined based on patient and/or clinician feedback indicating how well the dental appliances were retained on the patient's teeth.

Based on the training data 410, the machine learning model 406 can learn to distinguish between training samples in which high retention is observed and training samples in which low retention is observed. As the appliance data 414 may include dental appliances that vary in one or more shape parameters (e.g., interproximal penetration, device-tooth offset, gingival trim, thickness, extent, staging, contact regions, friction features, anchor elements, and/or any other geometric features that can be created using 3D printing and/or thermoforming processes), the machine learning model 406 may be trained to make predictions based on the shape parameters. In some embodiments, the training process includes partitioning the training data 410 into training and test sets, or may involve cross-fold validation and/or other training techniques as will be understood by a person of ordinary skill in the art. Once trained, the machine learning model 406 can be configured to predict the retention parameter 408 for a particular tooth arrangement and dental appliance based on the digital representation of the tooth arrangement 402 and the digital representation of the dental appliance 404.

Although certain embodiments of FIGS. 4-7 are described herein with respect to CNNs, other types of machine learning models may alternatively or additionally be used to predict retention, such as recurrent neural networks (RNNs), generative adversarial networks (GANs), capsule networks (CapsNets), graph neural networks (GNNs), autoencoders, other types of artificial neural networks (ANNs), or any of the other machine learning algorithm types described herein.

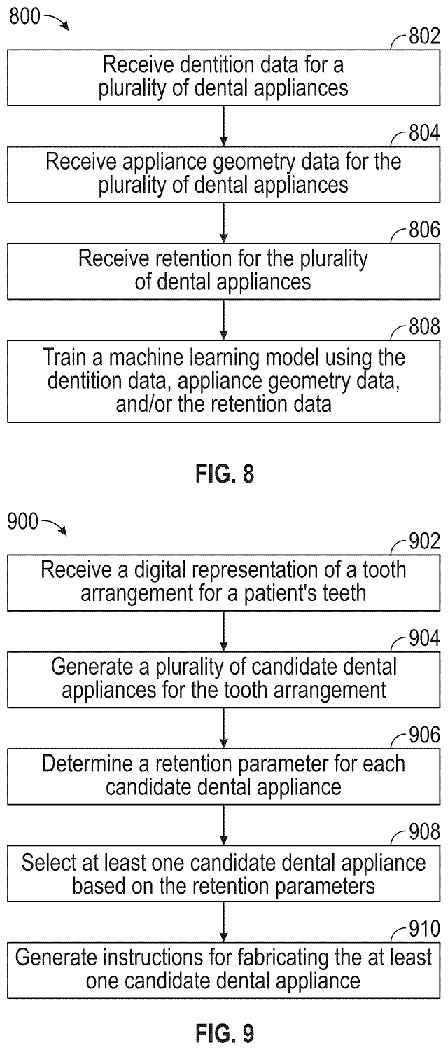

FIG. 8 is a flow diagram illustrating a method 800 for training a retention prediction model, in accordance with embodiments of the present technology. The method 800 can be used to train a machine learning model configured to predict the retention of candidate dental appliances for a given tooth arrangement, such as the model 406 of FIG. 4. In some embodiments, some or all of the method 800 is implemented as computer-readable instructions (e.g., program code) that are configured to be executed by one or more processors of a computing device (e.g., a client device, a server device, or suitable combinations thereof). The method 800 can be utilized and/or combined with any of the other methods described herein.

The method 800 can begin at block 802 with receiving dentition data. The dentition data can be generally similar to the dentition data 412 of the workflow 400 of FIG. 4. For instance, in some embodiments, the dentition data is based on data from a plurality of patients who are undergoing and/or have undergone dental treatment. The dentition data can include digital representations of tooth arrangements from the plurality of patients. In some embodiments, the digital representations can be any data type that provides information on each of the patient's teeth and/or intraoral anatomy. For instance, the dentition data can include imaging data (e.g., from intraoral scans). Alternatively or in combination, the dentition data may include simulated data, e.g., as discussed above with respect to the dentition data 412 of the workflow 400 of FIG. 4.

The method 800 can continue at block 804 with receiving appliance geometry data. The appliance geometry data can be generally similar to the appliance data 414 of the workflow 400 of FIG. 4. For instance, the appliance geometry data can include digital representations of actual dental appliances worn by a plurality of patients and/or digital representations of dental appliances generated by an appliance generation algorithm. In some embodiments, the appliance geometry data includes dental appliances that vary in one or more shape parameters such as interproximal penetration (depicted in FIGS. 1A and 1B), gingival trim (depicted in FIGS. 2A and 2B), device-tooth offset, appliance thickness, treatment staging, contact regions, friction features, anchor elements, and/or any other geometric features that can be created using 3D printing and/or thermoforming processes.

The method 800 can continue at block 806 with receiving retention data for the plurality of dental appliances. The retention data can be generally similar to the retention data 416 of the workflow 400 of FIG. 4. For instance, the retention data can be data indicating how well each dental appliance of the appliance geometry data is retained on a corresponding tooth arrangement of the dentition data. In some embodiments, a retention parameter may be assigned to each pair of dental appliance and tooth arrangement. The retention parameter can be generally similar to the retention parameters discussed elsewhere herein, such as the retention parameter 308 of the workflow 300 of FIG. 3.

In some embodiments, the processes of blocks 802, 804, and/or 806 occur simultaneously and/or substantially simultaneously. For instance, the dentition data, appliance geometry data, and retention data can be received by a computing device all at once. Alternatively, the processes of blocks 802, 804, and/or 806 may occur sequentially. The order in which the processes of blocks 802, 804, and/or 806 occur can be rearranged. For instance, the retention data may be received before the appliance geometry data, the appliance geometry data may be received before the dentition data, etc.

The method 800 can continue at block 808 with training a machine learning model (e.g., the machine learning model 406 of the workflow 400 of FIG. 4) using the dentition data, appliance geometry data, and/or retention data (collectively “training data”). In some embodiments, training the machine learning model includes partitioning the training data, e.g., using a train-test split, k-fold cross-validation, and/or other forms of data partitioning. For instance, the machine learning model can be trained using the training set, such that the model learns how to predict retention parameters from the training set. Thereafter, the machine learning model can be tested on the test set. A loss (e.g., error) can be computed based on the test set, such as by evaluating the difference between the known retention parameters and the predicted retention parameters, and the machine learning model can be retrained accordingly. In some embodiments, retraining the machine learning model includes modifying one or more parameters and/or hyperparameters of the machine learning model. For instance, when the machine learning model is a neural network, the modifiable parameters can include the number of layers, number of ‘neurons’ per layer, the type of cell, output dropout, state dropout, variational dropout, learning rate, decay factor, beta coefficient, maximum number of iterations, etc. Once the loss is below a predetermined error tolerance, the machine learning model is considered trained and can be configured to receive new appliance geometry data and/or dentition data and predict retention parameters based on the new data.

FIG. 9 is a flow diagram illustrating a method 900 for designing and/or manufacturing a dental appliance with improved retention, in accordance with embodiments of the present technology. The method 900 can be used before, during, and/or after a dental treatment for a patient. In some embodiments, some or all of the method 900 is implemented as computer-readable instructions (e.g., program code) that are configured to be executed by one or more processors of a computing device (e.g., a client device, a server device, or suitable combinations thereof). The method 900 can be utilized and/or combined with any of the other methods described herein.

The method 900 can begin at block 902 with receiving a digital representation of a tooth arrangement for a patient's teeth. The digital representation of the tooth arrangement can be generally similar to the digital representations of tooth arrangements discussed elsewhere herein, such as the digital representation of the tooth arrangement 302 of the workflow 300 of FIG. 3. For instance, the digital representation of the tooth arrangement can include data pertaining to the patient's teeth and/or intraoral anatomy. The data may be based on a tooth arrangement prior to a dental treatment, during a dental treatment, and/or after a dental treatment.

At block 904, the method 900 can continue with generating a plurality of candidate dental appliances for the tooth arrangement. Each candidate dental appliance can be designed to be worn on the patient's teeth to move the teeth toward the tooth arrangement (e.g., if the candidate dental appliances are aligners or palatal expanders) or to maintain the teeth in the tooth arrangement (e.g., if the candidate dental appliances are retainers). The candidate dental appliances can include dental appliances that vary in geometry. For instance, the candidate dental appliances may vary from one another in one or more shape parameters including interproximal penetration (e.g., as shown in FIGS. 1A and 1B), gingival trim (e.g., as shown in FIGS. 2A and 2B), appliance-tooth offset, thickness, staging, extent of coverage, contact regions, friction features, anchor elements, and/or any other geometric features that can be created using 3D printing and/or thermoforming processes, as discussed with respect to FIGS. 1A-2B.

Candidate dental appliances can be generated using simulations, estimates, and/or other modeling approaches. In some embodiments, the plurality of candidate dental appliances can be generated using an appliance generation algorithm. The plurality of candidate dental appliances can be automatically generated, e.g., based on a given tooth arrangement. Additionally or alternatively, the plurality of candidate dental appliances can be generated with the assistance of user input. For instance, a dental practitioner may prescribe certain shape parameter ranges that the plurality of dental appliances can adopt. Optionally, the generation of the candidate dental appliances may consider desired treatment goals (e.g., repositioning teeth). In some embodiments, the appliance generation algorithm can be part of an optimization algorithm, such as a multi-variate normal distributions with self-adaptive variance matrices (MNSV) algorithm.

The plurality of candidate dental appliances can include at least one, five, 10, 50, 100, 1000, 10,000, or more candidate dental appliances. In some embodiments, at least two of the plurality of candidate dental appliances share at least one shape parameter. For instance, a first and second candidate dental appliance of the plurality of candidate dental appliances can have the same and/or similar interproximal penetration depths but may vary in the gingival trim and/or other shape parameters as discussed elsewhere herein. Optionally, the candidate dental appliances may include candidate dental appliances tailored to alternative treatment options. For instance, a first candidate dental appliance of the plurality of candidate dental appliances may represent an accelerated treatment, whereas a second candidate dental appliance of the plurality of candidate dental appliances may represent a prolonged treatment.

The process of block 904 can include generating a digital representation of each candidate dental appliance. In some embodiments, the digital representation of each candidate dental appliance is combined with the digital representation of the tooth arrangement. For instance, the digital representation of the dental appliance can be overlaid onto the digital representation of the tooth arrangement to produce a single digital representation (e.g., as depicted in the architecture 600 of FIG. 6). Alternatively, the digital representation of each candidate dental appliance can be separate from the digital representation of the tooth arrangement (e.g., as depicted in the architecture 700 of FIG. 7).

At block 906, the method 900 can include determining a retention parameter for each candidate dental appliance. The retention parameter can be predicted and/or generated using a retention prediction algorithm, such as any of the embodiments described herein. For instance, the retention parameter can be generated using a machine learning model trained to predict dental appliance retention. The machine learning model may be a CNN, as discussed above with respect to the workflow 400 of FIG. 4, the architecture 600 of FIG. 6, and/or the architecture 700 of FIG. 7. The retention parameter can be generally similar to any of the retention parameters discussed elsewhere herein, such as the retention parameter 308 of the workflow 300 of FIG. 3. For instance, the retention parameter 308 can indicate how well the candidate dental appliance is retained on the tooth arrangement and can be quantitative, qualitative, or a combination thereof.

At block 908, the method 900 can include selecting at least one candidate dental appliance based on the retention parameters. In some embodiments, the selection is based on the candidate dental appliance(s) with the highest retention parameter(s) (e.g., the highest retention score(s)). Alternatively, the selection can include selecting candidate dental appliances having a retention parameter that is greater than a predetermined threshold (e.g., a minimum retention score, such as a retention score of at least 0.5, 0.6, 0.7, 0.8, or 0.9 out of 1). Further, it may be desirable to avoid over-retention, where the dental appliance is uncomfortable, obstructive, and/or difficult to remove from the tooth arrangement. Accordingly, the selection may include selecting candidate dental appliances that additionally or alternatively have a retention parameter that is less than a predetermined threshold (e.g., a maximum retention score). Optionally, the selection can be a categorical selection, such as a selection of candidate dental appliances that are included in a desirable category (e.g., “satisfactory retention”) and/or not included within an undesirable category (e.g., “over-retention”).

At block 910, the method 900 can continue with generating instructions for fabricating the at least one candidate dental appliance. The instructions can be any data type that can be used by a manufacturing system for fabricating the selected candidate dental appliance(s). For example, the fabrication instructions can include a digital representation of the selected appliance(s) and/or can include other data generated based on the digital representation, such as a toolpath file (e.g., G-code file). In some embodiments, the dental appliance(s) are fabricated using an additive manufacturing system, e.g., via a layer-by-layer additive manufacturing process such as stereolithography, digital light processing, selective laser sintering, material jetting, material extrusion, etc.

The method 900 illustrated in FIG. 9 can be modified in many different ways. For example, although the above processes of the method 900 are described with respect to a designing and/or fabricating candidate dental appliances for a single tooth arrangement, the method 900 can be used to sequentially or concurrently design and/or fabricate candidate dental appliances for a plurality of tooth arrangements, e.g., some or all of the tooth arrangements for a dental treatment plan. As another example, the ordering of the processes shown in FIG. 9 can be varied. Some of the processes of the method 900 can be omitted, and/or the method 900 can include processes not shown in FIG. 9.

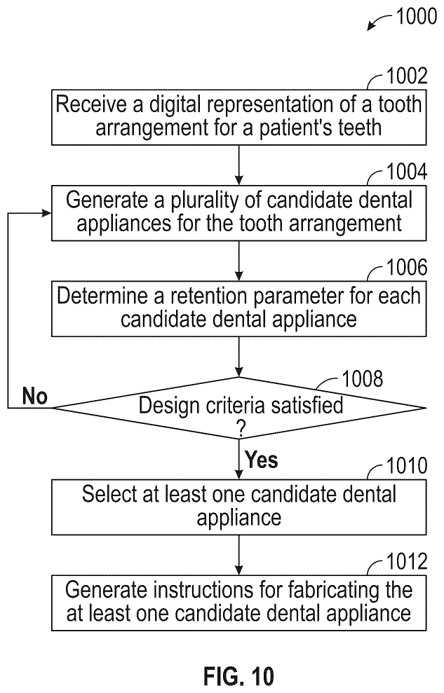

FIG. 10 is a flow diagram illustrating a method 1000 for designing and/or manufacturing a dental appliance with improved retention, in accordance with embodiments of the present technology. The method 1000 can be used before, during, and/or after a dental treatment for a patient. In some embodiments, some or all of the method 1000 is implemented as computer-readable instructions (e.g., program code) that are configured to be executed by one or more processors of a computing device (e.g., a client device, a server device, or suitable combinations thereof). The method 1000 can be utilized and/or combined with any of the other methods described herein.

The method 1000 can include receiving a digital representation of a tooth arrangement for a patient's teeth (block 1002), generating a plurality of candidate dental appliances for the tooth arrangement (block 1004), and determining a retention parameter for each candidate dental appliance (block 1006). The processes of blocks 1002, 1004, and 1006 may be identical or generally similar to the processes of blocks 902, 904, and 906 of the method 900 of FIG. 9.

At block 1008, the method 1000 can evaluate whether each candidate dental appliance satisfies one or more design criteria. In some embodiments, the one or more design criteria include an evaluation of retention of the dental appliance on the tooth arrangement. For instance, as discussed above with respect to block 908 of the method 900 of FIG. 9, the evaluation of retention can include comparing a retention parameter of each candidate dental appliance with a retention parameter threshold (e.g., a minimum retention score and/or a maximum retention score and/or categorical qualifier (e.g., “satisfactory retention”). In some embodiments, satisfying the one or more design criteria includes having a retention parameter that provides for adequate retention, as determined by the comparison.

Additionally or alternatively, design criteria can include other criteria, such as force application, aesthetics, treatment timing, comfort, obstructiveness, difficulty of manufacture, material costs, clinician preference, patient preference, etc. For instance, it may be desirable to have similar appliance-tooth offsets for some or all of the patient's teeth. As another example, excessively long gingival trim may be undesirable due to poor aesthetics and/or patient discomfort. In a further example, excessively thick or thin dental appliances may be challenging to manufacture. In yet another example, the forces produced by the dental appliance may need to stay within a particular range, e.g., the forces are sufficiently high for therapeutic efficacy but not so high as to cause discomfort and/or safety issues. In some embodiments, block 1008 involves evaluating a cost function, where the design criteria are satisfied if a computed cost is below a pre-determined threshold and/or is minimized. For instance, the cost function can be based on a weighted evaluation of each of the design criteria, e.g., adequate retention may be weighted more heavily than appliance aesthetics.

In some embodiments, the process of block 1008 can be performed using an evaluation algorithm. The evaluation algorithm can be part of an optimization algorithm (e.g., an MNSV algorithm). In some embodiments, input to the evaluation algorithm can be the retention parameter of the dental appliance and/or other relevant inputs such as treatment information, force profiles, materials, etc. The evaluation algorithm can evaluate one or more cost functions, based on the inputs, and can generate an output indicative of whether the design criteria are satisfied (e.g., whether the cost is below a predetermined threshold and/or is minimized).

If the design criteria are not satisfied, the method 1000 can return to block 1004 with generating additional candidate dental appliances for the tooth arrangement (e.g., via an appliance generation algorithm, as discussed above with respect to block 1004 and block 904 of the method 900 of FIG. 9). In some embodiments, generating additional candidate dental appliances includes generating candidate dental appliances different from the initial plurality of candidate dental appliances. Alternatively or additionally, generating additional candidate dental appliances can include modifying the initial plurality of candidate dental appliances.

In some embodiments, the modification(s) and/or additional candidate dental appliances are based on one or more of optimization algorithms, user input, and/or design criteria evaluation results. For instance, the modification(s) and/or additional candidate dental appliances can be based on iterative changes to one or more shape parameters (e.g., interproximal penetration, gingival trim, appliance-tooth offset, contact regions, friction features, anchor elements, and/or any other geometric features that can be created using 3D printing and/or thermoforming processes) until the design criteria are satisfied. For instance, if the evaluation of the design criteria indicated that the appliance is obtrusive to the patient, the modification can include reducing a thickness of the candidate dental appliance until the design criteria are satisfied. As another example, the modification(s) and/or additional candidate dental appliances can be based on a local retention parameter, e.g., regions where the local retention parameter was inadequate may be subject to modification of one or more shape parameters until the design criteria are satisfied.

The method 1000 can then proceed to block 1006 with determining retention parameters for the additional candidate dental appliances, and then to block 1008 with evaluating whether the additional appliances satisfy the design criteria. This process can be iterated until one or more candidate dental appliances satisfy the design criteria.

Once the design criteria are satisfied, the method 1000 can proceed to block 1010 with selecting at least one candidate dental appliance. The selection of the at least one candidate dental appliance can be based on the design criteria. The selection can be automatic or can be based on user input. In some embodiments, the selection includes selecting a candidate dental appliance with an adequate retention parameter and/or other satisfactory design criteria. Optionally, design criteria may be weighted, e.g., based on patient preference, clinician preference, requirements or constraints of the treatment plan, etc. For instance, the design criteria may assign a greater weight to retention than to appliance aesthetics. In some embodiments, certain criteria of the design criteria may be required (e.g., pass/fail) such that a candidate dental appliance cannot satisfy the design criteria unless the candidate dental appliance satisfies those criteria. Conversely, certain criteria of the design criteria may be optional, such that the candidate dental appliance may be selected even if those criteria are not satisfied. The weight assignment and/or selection of required/optional design criteria may be determined by the evaluation and/or optimization algorithms or may be based on user input (e.g., feedback from the patient and/or clinician). The selection may additionally or alternatively consider the cost function as discussed above with respect to block 1008. For instance, a candidate dental appliance with minimal cost (e.g., based on multiple design criteria) may be selected.

At block 1012, the method 1000 can continue with generating instructions for fabricating the at least one candidate dental appliance. The process of block 1012 can be identical or generally similar to the process of block 910 of the method 900 of FIG. 9.

The method 1000 illustrated in FIG. 10 can be modified in many different ways. For example, although the above processes of the method 1000 are described with respect to a designing and/or fabricating candidate dental appliances for a single tooth arrangement, the method 1000 can be used to sequentially or concurrently design and/or fabricate candidate dental appliances for a plurality of tooth arrangements, e.g., some or all of the tooth arrangements for a dental treatment plan. As another example, the ordering of the processes shown in FIG. 10 can be varied. Some of the processes of the method 1000 can be omitted, and/or the method 1000 can include processes not shown in FIG. 10.

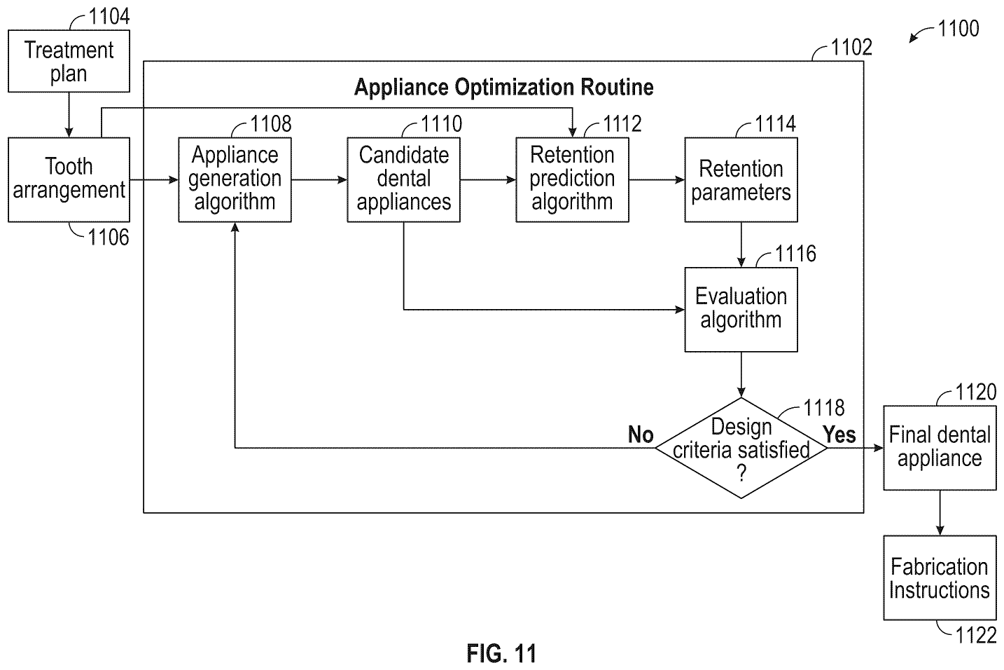

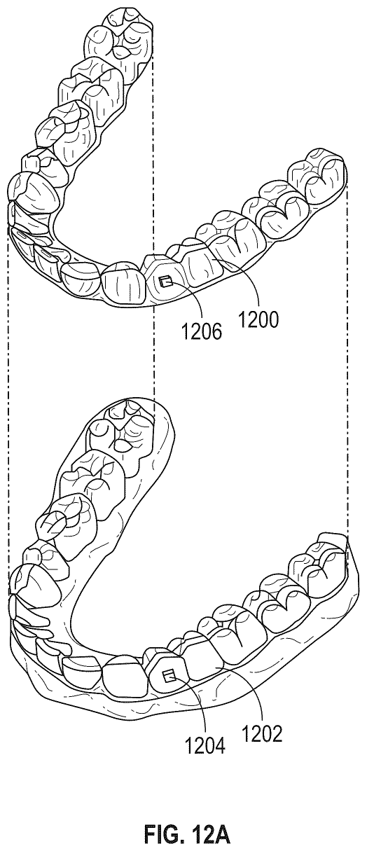

FIG. 11 is a block diagram illustrating a workflow 1100 for designing and/or manufacturing a dental appliance with improved retention, in accordance with embodiments of the present technology. The workflow 1100 can be used before, during, and/or after a dental treatment for a patient. In some embodiments, some or all of the workflow 1100 is implemented as computer-readable instructions (e.g., program code) that are configured to be executed by one or more processors of a computing device (e.g., a dental appliance design system). The workflow 1100 can be utilized and/or combined with any of the methods described herein (e.g., the method 1000 of FIG. 10).

The workflow 1100 can include an appliance optimization routine 1102 configured to design dental appliances with improved retention based on a treatment plan 1104 and tooth arrangement 1106. The treatment plan 1104 can include a plurality of treatment stages for incrementally repositioning a patient's teeth from an initial arrangement toward a target arrangement (e.g., via one or more aligners and/or palatal expanders). Optionally, the treatment plan 1104 can include a post-treatment stage in which the teeth are maintained in a target arrangement (e.g., via a retainer). The treatment plan 1104 can further include patient and/or clinically-relevant information pertaining to the patient's dental condition. The treatment plan 1104 can further include desired treatment goals for the patient. Optionally, the treatment plan 1104 can include constraints that may be factored in determining suitable treatments and appliances thereof, such as patient preferences, clinician preferences, etc.

The tooth arrangement 1106 can be one of the tooth arrangements specified by the treatment plan 1104, such as the initial arrangement, the target arrangement, or an intermediate arrangement. In some embodiments, the tooth arrangement 1106 is received by an appliance generation algorithm 1108 of the appliance optimization routine 1102. The appliance generation algorithm can be configured to generate a plurality of candidate dental appliances 1110 for the tooth arrangement 1106. The generation of the plurality of candidate dental appliances 1110 can be generally similar to the generation of candidate dental appliances described elsewhere herein, such as with respect to block 1004 of the method 1000 of FIG. 10. In some embodiments, the appliance generation algorithm 1108 is part of an optimization algorithm, such as an MNSV algorithm.

In some embodiments, the candidate dental appliances 1110 and the tooth arrangement 1106 are input into a retention prediction algorithm 1112. The candidate dental appliances 1110 and the tooth arrangement 1106 can be input into the retention prediction algorithm 1112 together (e.g., as depicted in the architecture 600 of FIG. 6) or separately (e.g., as depicted in the architecture 700 of FIG. 7). The candidate dental appliances 1110 and/or the tooth arrangement 1106 may be provided to the retention prediction algorithm 1112 in any suitable format, such as image data (e.g., image slices, a volumetric image), or as one or more tensors generated from the image data (e.g., similar to the tensor 610 of the architecture 600 of FIG. 6 and/or the tensors 712 of the architecture 700 of FIG. 7).

The retention prediction algorithm 1112 can be identical or generally similar to any of the retention prediction algorithms 1112 discussed elsewhere herein, such as the retention prediction algorithm 306 of the workflow 300 of FIG. 3. In some embodiments, for example, the retention prediction algorithm 1112 includes a trained machine learning model, such as a CNN. The machine learning model may be trained in accordance with any of the training methods described herein, such as the training discussed with respect to the training data 410 and machine learning model 406 of the workflow 400 of FIG. 4 and/or as discussed with respect to block 808 of the method 800 of FIG. 8. In some embodiments, the retention prediction algorithm 1112 includes an architecture similar to the architecture 600 of FIG. 6 or the architecture 700 of FIG. 7.

The retention prediction algorithm 1112 can be configured to output retention parameters 1114 for each of the candidate dental appliances 1110. The retention parameters 1114 can be generally similar to any of the retention parameters discussed herein, such as the retention parameter 308 of the workflow 300 of FIG. 3. For instance, the retention parameters 1114 can indicate how well each of the candidate dental appliances 1110 is retained on the tooth arrangement 1106.

The workflow 1100 can further include evaluating the candidate dental appliances 1110 and/or the retention parameters 1114 using an evaluation algorithm 1116. The evaluation of the candidate dental appliances can be generally similar to the selection and evaluation processes of the block 1010 of the method 1000 of FIG. 10. For instance, the evaluation algorithm 1116 can be configured to assess the candidate dental appliances 1110 against one or more design criteria including retention, force application, aesthetics, treatment timing, comfort, obstructiveness, difficulty of manufacture, material costs, clinician preference, patient preference, etc. The evaluation algorithm 1116 can evaluate one or more cost functions based on the retention parameters and/or other design criteria. In some embodiments, the evaluation algorithm 1116 is part of an optimization algorithm, such as an MNSV algorithm.

Using the evaluation algorithm 1116, the workflow 1100 can further include determining whether the design criteria are satisfied (at block 1118). The determination can be identical or generally similar to the processes described in block 1008 of the method 1000 of FIG. 10. For instance, outputs from the evaluation algorithm 1116 (e.g., device design features) can be compared to one or more thresholds or be inputted into a cost function.

If the design criteria are not satisfied, then the appliance optimization routine 1102 can return to the appliance generation algorithm 1108 to generate additional candidate dental appliances 1110. As discussed above with respect to the processes of blocks 1004, 1006, and 1008 of the method 1000 of FIG. 10, the additional candidate dental appliances 1110 can be different candidate dental appliances 1110 from the initial candidate dental appliances 1110 or can include modifications of the initial candidate dental appliances 1110. Similar to the return loop in the method 1000 of FIG. 10, the appliance optimization routine 1102 can iteratively generate additional candidate dental appliances 1110 via the appliance generation algorithm 1108 and evaluate the additional candidate dental appliance 1110 via the retention prediction algorithm 1112 and the evaluation algorithm 1116 until the design criteria are satisfied (block 1118).

Once the design criteria are satisfied, the appliance optimization routine 1102 can continue with outputting a final dental appliance 1120. Outputting the final dental appliance 1120 can include selecting the final dental appliance 1120 from the candidate dental appliances 1110. For instance, the final dental appliance 1120 can be the best-performing candidate dental appliance 1110 based on the evaluation algorithm 1116 and/or the design criteria determination (block 1118). Optionally, other considerations may be used to select the final dental appliance 1120, such as patient and/or clinician preferences.

Once the final dental appliance 1120 has been produced, the workflow 1100 can further generate fabrication instructions 1122. The instructions 1122 can be any data type that can be used by a manufacturing system for fabricating the selected candidate dental appliance(s). For example, the fabrication instructions 1122 can include a digital representation of the selected appliance(s) and/or can include other data generated based on the digital representation, such as a toolpath file (e.g., G-code file). In some embodiments, the dental appliance(s) are fabricated using an additive manufacturing system, e.g., via a layer-by-layer additive manufacturing process.

### II. Dental Appliances and Associated Methods

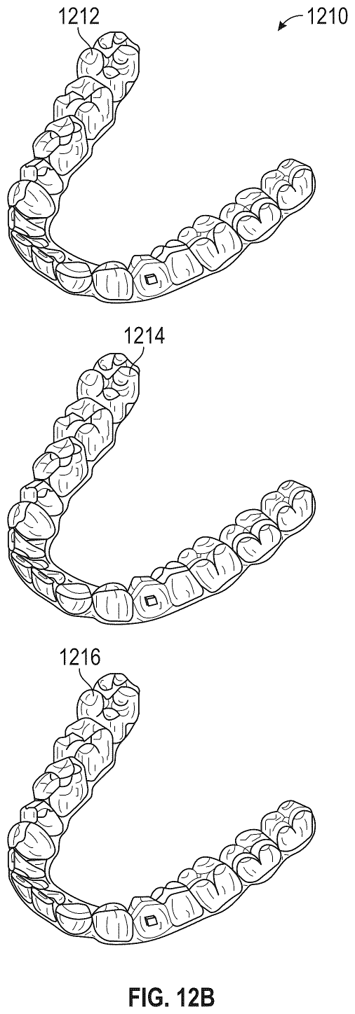

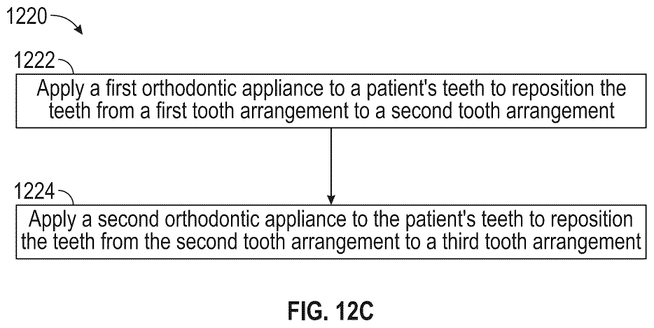

FIG. 12A illustrates a representative example of a tooth repositioning appliance 1200 configured in accordance with embodiments of the present technology. The appliance 1200 can be designed and/or manufactured using any of the systems, methods, and devices described herein. The appliance 1200 (also referred to herein as an “aligner”) can be worn by a patient in order to achieve an incremental repositioning of individual teeth 1202 in the jaw. The appliance 1200 can include a shell (e.g., a continuous polymeric shell or a segmented shell) having teeth-receiving cavities that receive and resiliently reposition the teeth. The appliance 1200 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1200 can fit over all teeth present in an upper or lower jaw, or less than all of the teeth. The appliance 1200 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1200 can be a generic appliance configured to receive the teeth, but not necessarily shaped to match the topography of the patient's teeth. In some cases, only certain teeth received by the appliance 1200 are repositioned by the appliance 1200 while other teeth can provide a base or anchor region for holding the appliance 1200 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 1200 in place over the teeth. In some cases, however, it may be desirable or necessary to provide individual attachments 1204 or other anchoring elements on teeth 1202 with corresponding receptacles 1206 or apertures in the appliance 1200 so that the appliance 1200 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 12B illustrates a tooth repositioning system 1210 including a plurality of appliances 1212, 1214, 1216, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1210 can include a first appliance 1212 corresponding to an initial tooth arrangement, one or more intermediate appliances 1214 corresponding to one or more intermediate arrangements, and a final appliance 1216 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 12C illustrates a method 1220 of orthodontic treatment using a plurality of appliances, in accordance with embodiments of the present technology. The method 1220 can be practiced using any of the appliances or appliance sets described herein. In block 1222, a first orthodontic appliance is applied to a patient's teeth in order to reposition the teeth from a first tooth arrangement to a second tooth arrangement. In block 1224, a second orthodontic appliance is applied to the patient's teeth in order to reposition the teeth from the second tooth arrangement to a third tooth arrangement. The method 1220 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

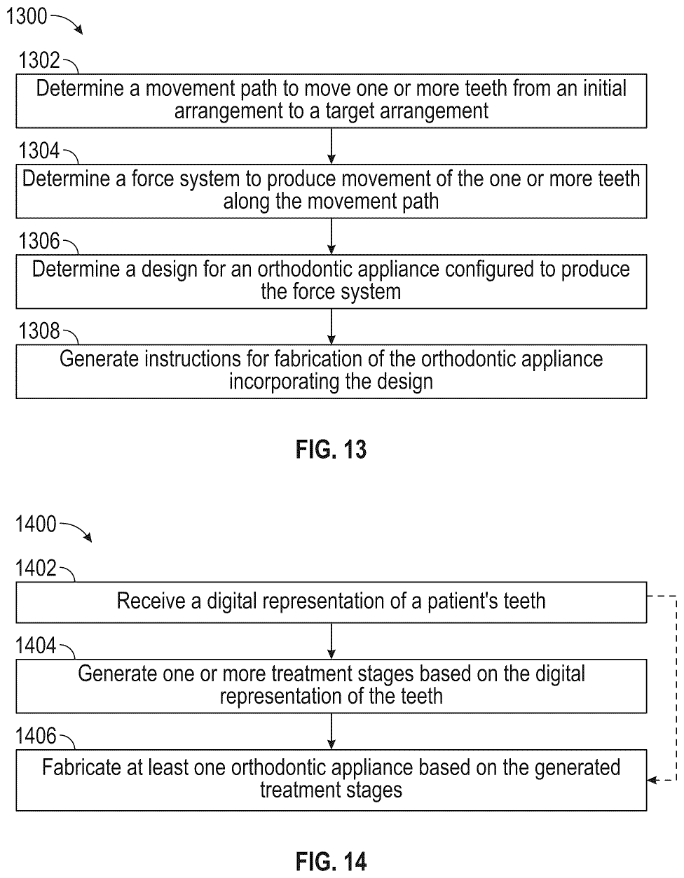

FIG. 13 illustrates a method 1300 for designing an orthodontic appliance, in accordance with embodiments of the present technology. The method 1300 can be applied to any embodiment of the orthodontic appliances described herein. Some or all of the steps of the method 1300 can be performed by any suitable data processing system or device, e.g., one or more processors configured with suitable instructions.

In block 1302, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1304, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1304 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1306, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate dental appliance. One or more modifications can optionally be made to a candidate dental appliance, and force modeling can be further analyzed as described, e.g., in order to iteratively determine an appliance design that produces the desired force system.

In block 1308, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1300 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1300 may be performed with any suitable fabrication system or device, such as the embodiments described herein. Some of the steps may be optional, e.g., the process of block 1304 can be omitted, such that the orthodontic appliance is designed based on the desired tooth movements and/or determined tooth movement path, rather than based on a force system. Moreover, the order of the steps can be varied as desired.

FIG. 14 illustrates a method 1400 for digitally planning an orthodontic treatment and/or design or fabrication of an appliance, in accordance with embodiments. The method 1400 can be applied to any of the treatment procedures described herein and can be performed by any suitable data processing system.

In block 1402 a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1404, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1406, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 14, design and/or fabrication of an orthodontic appliance, and perhaps a particular orthodontic treatment, may include use of a representation of the patient's teeth (e.g., including receiving a digital representation of the patient's teeth (block 1402)), followed by design and/or fabrication of an orthodontic appliance based on a representation of the patient's teeth in the arrangement represented by the received representation.

As noted herein, the techniques described herein can be used for the design and/or manufacture of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to design and/or manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to design and/or manufacture incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The following examples are included to further describe some aspects of the present technology, and should not be used to limit the scope of the technology.

Example 1. A method comprising:
receiving a digital representation of a tooth arrangement for a patient's teeth;
generating a plurality of candidate dental appliances for the tooth arrangement;
determining a retention parameter for each candidate dental appliance of the plurality of candidate dental appliances, wherein the retention parameter is indicative of how well the candidate dental appliance is retained on the patient's teeth;
selecting at least one candidate dental appliance based on the retention parameters for the plurality of candidate dental appliances; and
generating instructions for fabricating the at least one candidate dental appliance.

Example 2. The method of Example 1, wherein determining the retention parameter for each candidate dental appliance comprises inputting a digital representation of the candidate dental appliance into a machine learning model, wherein the machine learning model is trained to generate the retention parameter based on the digital representation of the candidate dental appliance.

Example 3. The method of Example 2, wherein the machine learning model is trained based on appliance geometry data and retention data from a plurality of dental appliances.

Example 4. The method of Example 3, wherein the plurality of dental appliances have different shape parameters.

Example 5. The method of Example 3 or 4, wherein the retention data comprises simulation data, experimental data, or a combination thereof.

Example 6. The method of any one of Examples 2 to 5, wherein the digital representation of the candidate dental appliance comprises a 3D model, a plurality of 2D images generated from the 3D model, or a combination thereof.

Example 7. The method of any one of Examples 2 to 6, wherein determining the retention parameter for each candidate dental appliance further comprises inputting the digital representation of the tooth arrangement into the machine learning model.

Example 8. The method of Example 7, wherein the digital representation of the candidate dental appliance is separate from the digital representation of the tooth arrangement.

Example 9. The method of Example 7, wherein the digital representation of the candidate dental appliance is combined with the digital representation of the tooth arrangement.

Example 10. The method of any one of Examples 2 to 9, wherein the machine learning model comprises a convolutional neural network.

Example 11. The method of any one of Examples 1 to 10, wherein the retention parameter comprises a quantitative score, a qualitative score, or a combination thereof.

Example 12. The method of any one of Examples 1 to 11, wherein the retention parameter comprises a local retention parameter for each tooth of the tooth arrangement.

Example 13. The method of any one of Examples 1 to 12, wherein the retention parameter comprises a global retention parameter for the tooth arrangement.

Example 14. The method of any one of Examples 1 to 13, wherein the plurality of candidate dental appliances differ from each other with respect to one or more of the following: appliance-tooth offset, gingival trim, interproximal penetration, thickness, contact regions, friction features, anchor elements, or staging.

Example 15. The method of any one of Examples 1 to 14, wherein selecting the at least one candidate dental appliance comprising selecting a candidate dental appliance having a retention parameter that is above a threshold value indicative of satisfactory retention on the patient's teeth.

Example 16. The method of any one of Examples 1 to 15, wherein selecting the at least one candidate dental appliance comprising selecting a candidate dental appliance having a retention parameter that is below a threshold value indicative of over-retention on the patient's teeth.

Example 17. The method of any one of Examples 1 to 16, wherein the at least one candidate dental appliance is selected using an evaluation algorithm.

Example 18. The method of Example 17, wherein the evaluation algorithm is configured to determine whether each candidate dental appliance satisfies one or more design criteria.

Example 19. The method of Example 18, wherein in response to a determination that the plurality of candidate dental appliances do not satisfy the one or more design criteria, the method further comprises:
generating a plurality of second candidate dental appliances for the tooth arrangement,
determining a retention parameter for each second candidate dental appliance of the plurality of second candidate dental appliances, and
determining whether each second candidate dental appliance satisfies the one or more design criteria using the evaluation algorithm.

Example 20. The method of any one of Examples 1 to 19, wherein the plurality of candidate dental appliances are generated using an appliance generation algorithm.

Example 21. The method of any one of Examples 17 to 20, wherein the appliance generation algorithm and the evaluation algorithm are part of a multi-variate normal distributions with self-adaptive variance matrices (MNSV) algorithm.

Example 22. The method of any one of Examples 1 to 21, wherein the plurality of candidate dental appliances comprise a plurality of aligners configured to reposition the patient's teeth toward the tooth arrangement.

Example 23. The method of any one of Examples 1 to 22, wherein the plurality of candidate dental appliances comprise a plurality of retainers configured to maintain the patient's teeth in the tooth arrangement.

Example 24. The method of any one of Examples 1 to 23, wherein the plurality of candidate dental appliances are configured to be worn on the patient's teeth without any dental attachments on the patient's teeth.

Example 25. The method of any one of Examples 1 to 24, wherein the tooth arrangement corresponds to a treatment stage of a treatment plan for the patient's teeth.

Example 26. The method of Example 25, wherein the treatment plan comprises repositioning the patient's teeth from an initial tooth arrangement toward a target tooth arrangement via a plurality of intermediate tooth arrangements, and wherein the tooth arrangement is an intermediate tooth arrangement or the target tooth arrangement of the treatment plan.

Example 27. The method of any one of Examples 1 to 26, further comprising fabricating the at least one candidate dental appliance based on the instructions.

Example 28. A system comprising:
one or more processors; and
a memory operably coupled to the one or more processors and storing instructions that, when executed by the one or more processors, cause the system to perform operations comprising:
   receiving a digital representation of a tooth arrangement for a patient's teeth;
   generating a plurality of candidate dental appliances for the tooth arrangement;
   determining a retention parameter for each candidate dental appliance of the plurality of candidate dental appliances, wherein the retention parameter is indicative of how well the candidate dental appliance is retained on the patient's teeth;
   selecting at least one candidate dental appliance based on the retention parameters for the plurality of candidate dental appliances; and
   generating instructions for fabricating the at least one candidate dental appliance.

Example 29. The system of Example 28, wherein determining the retention parameter for each candidate dental appliance comprises inputting a digital representation of the candidate dental appliance into a machine learning model, wherein the machine learning model is trained to generate the retention parameter based on the digital representation of the candidate dental appliance.

Example 30. The system of Example 29, wherein the machine learning model is trained based on appliance geometry data and retention data from a plurality of dental appliances.

Example 31. The system of Example 30, wherein the plurality of dental appliances have different shape parameters.

Example 32. The system of Example 30 or 31, wherein the retention data comprises simulation data, experimental data, or a combination thereof.

Example 33. The system of any one of Examples 29 to 32, wherein the digital representation of the candidate dental appliance comprises a 3D model, a plurality of 2D images generated from the 3D model, or a combination thereof.

Example 34. The system of any one of Examples 29 to 33, wherein determining the retention parameter for each candidate dental appliance further comprises inputting the digital representation of the tooth arrangement into the machine learning model.

Example 35. The system of Example 34, wherein the digital representation of the candidate dental appliance is separate from the digital representation of the tooth arrangement.

Example 36. The system of Example 34, wherein the digital representation of the candidate dental appliance is combined with the digital representation of the tooth arrangement.

Example 37. The system of any one of Examples 29 to 36, wherein the machine learning model comprises a convolutional neural network.

Example 38. The system of any one of Examples 28 to 37, wherein the retention parameter comprises a quantitative score, a qualitative score, or a combination thereof.

Example 39. The system of any one of Examples 28 to 38, wherein the retention parameter comprises a local retention parameter for each tooth of the tooth arrangement.

Example 40. The system of any one of Examples 28 to 39, wherein the retention parameter comprises a global retention parameter for the tooth arrangement.

Example 41. The system of any one of Examples 28 to 40, wherein the plurality of candidate dental appliances differ from each other with respect to one or more of the following: appliance-tooth offset, gingival trim, interproximal penetration, thickness, contact regions, friction features, anchor elements, or staging.

Example 42. The system of any one of Examples 28 to 41, wherein selecting the at least one candidate dental appliance comprising selecting a candidate dental appliance having a retention parameter that is above a threshold value indicative of satisfactory retention on the patient's teeth.

Example 43. The system of any one of Examples 28 to 42, wherein selecting the at least one candidate dental appliance comprising selecting a candidate dental appliance having a retention parameter that is below a threshold value indicative of over-retention on the patient's teeth.

Example 44. The system of any one of Examples 28 to 43, wherein the at least one candidate dental appliance is selected using an evaluation algorithm.

Example 45. The system of Example 44, wherein the evaluation algorithm is configured to determine whether each candidate dental appliance satisfies one or more design criteria.

Example 46. The system of Example 45, wherein in response to a determination that the plurality of candidate dental appliances do not satisfy the one or more design criteria, the operations further comprise:
generating a plurality of second candidate dental appliances for the tooth arrangement,
determining a retention parameter for each second candidate dental appliance of the plurality of second candidate dental appliances, and
determining whether each second candidate dental appliance satisfies the one or more design criteria using the evaluation algorithm.

Example 47. The system of any one of Examples 28 to 46, wherein the plurality of candidate dental appliances are generated using an appliance generation algorithm.

Example 48. The system of any one of Examples 44 to 47, wherein the appliance generation algorithm and the evaluation algorithm are part of a multi-variate normal distributions with self-adaptive variance matrices (MNSV) algorithm.

Example 49. The system of any one of Examples 28 to 48, wherein the plurality of candidate dental appliances comprise a plurality of aligners configured to reposition the patient's teeth toward the tooth arrangement.

Example 50. The system of any one of Examples 28 to 49, wherein the plurality of candidate dental appliances comprise a plurality of retainers configured to maintain the patient's teeth in the tooth arrangement.

Example 51. The system of any one of Examples 28 to 50, wherein the plurality of candidate dental appliances are configured to be worn on the patient's teeth without any dental attachments on the patient's teeth.

Example 52. The system of any one of Examples 28 to 51, wherein the tooth arrangement corresponds to a treatment stage of a treatment plan for the patient's teeth.

Example 53. The system of Example 52, wherein the treatment plan comprises repositioning the patient's teeth from an initial tooth arrangement toward a target tooth arrangement via a plurality of intermediate tooth arrangements, and wherein the tooth arrangement is an intermediate tooth arrangement or the target tooth arrangement of the treatment plan.

Example 54. The system of any one of Examples 28 to 53, wherein the operations further comprise fabricating the at least one candidate dental appliance based on the instructions.

Example 55. A non-transitory computer-readable storage medium comprising instructions that, when executed by one or more processors of a computing system, cause the computing system to perform operations comprising the method of any one of any one of Examples 1 to 27.

Example 56. A method comprising:
receiving appliance geometry data for a plurality of dental appliances having different shape parameters;
receiving retention data for the plurality of dental appliances, wherein the retention data is indicative of how well each dental appliance is retained on a patient's teeth; and
training a machine learning model using the appliance geometry data and the retention data, wherein the machine learning model is trained to generate a retention parameter based on a digital representation of a candidate dental appliance.

Example 57. The method of Example 56, wherein the appliance geometry data comprises a digital representation of each dental appliance of the plurality of dental appliances.

Example 58. The method of Example 57, wherein the digital representation of each dental appliance comprises a 3D model, a plurality of 2D images generated from the 3D model, or a combination thereof.

Example 59. The method of any one of Examples 56 to 58, wherein the different shape parameters comprise one or more of the following: appliance-tooth offset, gingival trim, interproximal penetration, thickness, contact regions, friction features, anchor elements, or staging.

Example 60. The method of any one of Examples 56 to 59, wherein the retention data comprises or is based on simulation data, experimental data, or a combination thereof.

Example 61. The method of any one of Examples 56 to 60, wherein the retention data comprises a retention parameter for each dental appliance.

Example 62. The method of Example 61, wherein the retention parameter comprises a quantitative score, a qualitative score, or a combination thereof.

Example 63. The method of any one of Examples 56 to 62, further comprising receiving dentition data comprising a digital representation of a tooth arrangement of a patient for each dental appliance, wherein the machine learning model is trained using the dentition data.

Example 64. The method of Example 63, further comprising generating appliance-dentition data by combining a digital representation of each dental appliance with the digital representation of the corresponding tooth arrangement, wherein the machine learning model is trained using the appliance-dentition data.

Example 65. The method of any one of Examples 56 to 64, wherein the machine learning model comprises a convolutional neural network.

Example 66. A system comprising:
one or more processors; and
a memory operably coupled to the one or more processors and storing instructions that, when executed by the one or more processors, cause the system to perform operations comprising:
   receiving appliance geometry data for a plurality of dental appliances having different shape parameters;
   receiving retention data for the plurality of dental appliances, wherein the retention data is indicative of how well each dental appliance is retained on a patient's teeth; and
   training a machine learning model using the appliance geometry data and the retention data, wherein the machine learning model is trained to generate a retention parameter based on a digital representation of a candidate dental appliance.

Example 67. The system of Example 66, wherein the appliance geometry data comprises a digital representation of each dental appliance of the plurality of dental appliances.

Example 68. The system of Example 67, wherein the digital representation of each dental appliance comprises a 3D model, a plurality of 2D images generated from the 3D model, or a combination thereof.

Example 69. The system of any one of Examples 66 to 68, wherein the different shape parameters comprise one or more of the following: appliance-tooth offset, gingival trim, interproximal penetration, thickness, contact regions, friction features, anchor elements, or staging.

Example 70. The system of any one of Examples 66 to 69, wherein the retention data comprises or is based on simulation data, experimental data, or a combination thereof.

Example 71. The system of any one of Examples 66 to 70, wherein the retention data comprises a retention parameter for each dental appliance.

Example 72. The system of Example 71, wherein the retention parameter comprises a quantitative score, a qualitative score, or a combination thereof.

Example 73. The system of any one of Examples 66 to 72, wherein the operations further comprise receiving dentition data comprising a digital representation of a tooth arrangement of a patient for each dental appliance, wherein the machine learning model is trained using the dentition data.

Example 74. The system of Example 73, wherein the operations further comprise generating appliance-dentition data by combining a digital representation of each dental appliance with the digital representation of the corresponding tooth arrangement, wherein the machine learning model is trained using the appliance-dentition data.

Example 75. The system of any one of Examples 66 to 74, wherein the machine learning model comprises a convolutional neural network.

Example 76. A non-transitory computer-readable storage medium comprising instructions that, when executed by one or more processors of a computing system, cause the computing system to perform operations comprising the method of any one of any one of Examples 56 to 65.

### CONCLUSION

Although many of the embodiments are described above with respect to systems, devices, and methods for dental appliance retention, the technology is applicable to other applications and/or other approaches, such as retention of other types of medical devices. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-14.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
receiving a digital representation of a tooth arrangement for a patient's teeth;
generating a plurality of candidate dental appliances for the tooth arrangement;
determining a retention parameter for each candidate dental appliance of the plurality of candidate dental appliances, wherein the retention parameter is indicative of how well the candidate dental appliance is retained on the patient's teeth;
selecting at least one candidate dental appliance based on the retention parameters for the plurality of candidate dental appliances; and
generating instructions for fabricating the at least one candidate dental appliance.

2. The method of claim 1, wherein determining the retention parameter for each candidate dental appliance comprises inputting a digital representation of the candidate dental appliance into a machine learning model, wherein the machine learning model is trained to generate the retention parameter based on the digital representation of the candidate dental appliance.

3. The method of claim 2, wherein the machine learning model is trained based on appliance geometry data and retention data from a plurality of dental appliances.

4. The method of claim 3, wherein the retention data comprises simulation data, experimental data, or a combination thereof.

5. The method of claim 2, wherein determining the retention parameter for each candidate dental appliance further comprises inputting the digital representation of the tooth arrangement into the machine learning model.

6. The method of claim 1, wherein the retention parameter comprises a local retention parameter for each tooth of the tooth arrangement.

7. The method of claim 1, wherein the plurality of candidate dental appliances differ from each other with respect to one or more of the following: appliance-tooth offset, gingival trim, interproximal penetration, thickness, contact regions, friction features, anchor elements, or staging.

8. The method of claim 1, wherein selecting the at least one candidate dental appliance comprising selecting a candidate dental appliance having a retention parameter that is above a threshold value indicative of satisfactory retention on the patient's teeth.

9. The method of claim 1, wherein selecting the at least one candidate dental appliance comprising selecting a candidate dental appliance having a retention parameter that is below a threshold value indicative of over-retention on the patient's teeth.

10. The method of claim 1, further comprising fabricating the at least one candidate dental appliance based on the instructions.

11. A system comprising:
one or more processors; and
a memory operably coupled to the one or more processors and storing instructions that, when executed by the one or more processors, cause the system to perform operations comprising:
receiving a digital representation of a tooth arrangement for a patient's teeth;
generating a plurality of candidate dental appliances for the tooth arrangement;
determining a retention parameter for each candidate dental appliance of the plurality of candidate dental appliances, wherein the retention parameter is indicative of how well the candidate dental appliance is retained on the patient's teeth;
selecting at least one candidate dental appliance based on the retention parameters for the plurality of candidate dental appliances; and
generating instructions for fabricating the at least one candidate dental appliance.

12. The system of claim 11, wherein determining the retention parameter for each candidate dental appliance comprises inputting a digital representation of the candidate dental appliance into a machine learning model, wherein the machine learning model is trained to generate the retention parameter based on the digital representation of the candidate dental appliance.

13. The system of claim 12, wherein the machine learning model is trained based on appliance geometry data and retention data from a plurality of dental appliances.

14. The system of claim 13, wherein the retention data comprises simulation data, experimental data, or a combination thereof.

15. The system of claim 12, wherein determining the retention parameter for each candidate dental appliance further comprises inputting the digital representation of the tooth arrangement into the machine learning model.

16. The system of claim 11, wherein the retention parameter comprises a local retention parameter for each tooth of the tooth arrangement.

17. The system of claim 11, wherein the plurality of candidate dental appliances differ from each other with respect to one or more of the following: appliance-tooth offset, gingival trim, interproximal penetration, thickness, contact regions, friction features, anchor elements, or staging.

18. The system of claim 11, wherein selecting the at least one candidate dental appliance comprising selecting a candidate dental appliance having a retention parameter that is above a threshold value indicative of satisfactory retention on the patient's teeth.

19. The system of claim 11, wherein selecting the at least one candidate dental appliance comprising selecting a candidate dental appliance having a retention parameter that is below a threshold value indicative of over-retention on the patient's teeth.

20. The system of claim 11, wherein the operations further comprise fabricating the at least one candidate dental appliance based on the instructions.
